(19) United States
(12) Patent Application Publication
(10) Pub. No.: US 2026/0225349 A1
(43) Pub. Date: Aug. 6, 2026

(54) FLAME AND THERMAL BARRIER MATERIALS

(71) Applicant: Blueshift Materials, Inc., Spencer, MA (US)

(72) Inventors: Lawino KAGUMBA, Spencer, MA (US); Marisa SNAPP-LEO, Spencer, MA (US); Hojat MAJEDI FAR, Spencer, MA (US); Daniel PEREIRA, Spencer, MA (US)

(73) Assignee: Blueshift Materials, Inc., Spencer, MA (US)

(21) Appl. No.: 19/149,964

(22) PCT Filed: Jan. 23, 2024
(86) PCT No.: PCT/US2024/012615

§ 371 Date: Jul. 22, 2025

Related U.S. Application Data
(63) Continuation-in-part of application No. PCT/US2023/061100, filed on Jan. 23, 2023.
(60) Provisional application No. 63/481,124, filed on Jan. 23, 2023.

(51) Int. Cl. B32B 15/14; B32B 5/02; B32B 5/18; B32B 7/12; B32B 9/00; B32B 9/04

(52) U.S. Cl. CPC B32B 15/14; B32B 5/024; B32B 5/18; B32B 7/12; B32B 9/007; B32B 9/047; B32B 2250/40; B32B 2262/0269; B32B 2262/101; B32B 2262/105; B32B 2262/108; B32B 2266/126; B32B 2305/08; B32B 2307/304; B32B 2307/3065; B32B 2307/718; B32B 2307/7376

(57) ABSTRACT

This disclosure contains flame and thermal barrier laminates and apparatuses including the same. Some laminates have a reinforcing layer comprising fibers, a flame-retardant layer having a flammability rating compliant with UL94 5VA, UL94 5VB, or UL94 V-0, a porous, thermally-insulative layer, and a heat-dispersing layer comprising at least 90%, by weight, of a metal or graphite, wherein a thickness of the laminate is less than or equal to 5 mm.

### CROSS REFERENCE TO RELATED APPLICATIONS

This application claims the benefit of U.S. Provisional Patent Application No. 63/481,124, filed Jan. 23, 2023, and claims priority to International Pat. App. No. PCT/US2023/061100, filed Jan. 23, 2023, which are hereby incorporated by reference in their entireties.

### BACKGROUND OF THE INVENTION

### A. Field of the Invention

The present invention relates generally to laminates that can be used as flame and/or thermal protection materials for all types of articles of manufacture. In some aspects, the laminates can be used to protect articles of manufacture (e.g., batteries, electronic devices, and/or the like) from environments where the articles of manufacture may be subjected to elevated temperatures (e.g., greater than 500° C.) for a given period of time (e.g., 1 minute to 90 minutes), in some instances, while such articles are simultaneously impacted with ejecta (e.g., caused by battery thermal runaway).

### B. Description of Related Art

The electrification of today's society is becoming more prevalent. An example of this is the rapid pace at which the electrification of the transportation sector is taking place. In particular, transportation vehicles such as automobiles, trains, and planes are moving away from combustion engine technology and are instead implementing electric motors that rely on battery systems. These battery systems can be complex systems that rely on chemicals, chemical reactions, electronic components, and other materials to store and release electricity for the electric motors.

One of the problems associated with battery systems used in electric vehicles is that they are larger and store and release far more energy when compared to battery systems used in typical transportation vehicles that rely primarily on combustion engine technology. The particular issue is that the batteries used in electric vehicles, if mechanically damaged (e.g., an automobile accident, malfunctioning in the wiring or electronics system, etc.), exposed to temperatures outside of their operating window, or subjected to rapid electrical charge and/or discharge events, can lead to comparatively larger explosions, larger fires, and/or release greater amounts of caustic chemical fumes when compared with batteries used in vehicles that rely on combustion engines. Lithium-ion based battery cells used in electric vehicles can catch fire and/or explode at temperatures of greater than 500° C. By comparison, vehicle fires caused, for example, by a vehicular accident, can generate heat upwards of 1,500° F. (815° C.). When an accident occurs with an electric vehicle and a fire ensues, there is a certain amount of time to either extinguish the flames and/or to exit and clear the vehicle before the battery catches fire and/or explodes. With the increasing electrification of society, and, in particular, the transportation infrastructure, as well as the increasing energy density of batteries, the risk of electric vehicle fires and battery fires and explosions will likely increase.

Traditional, thermally-insulative materials such as foams, polymers, and elastomers have been used to provide some thermal protection for electric vehicle battery systems. Unfortunately, these traditional materials continue to face limitations. For example, while polymeric foams have a low thermal conductivity to mitigate heat transfer, their thermal diffusivity—which is a material's thermal conductivity divided by its density and specific heat capacity—tends to be higher than that of other insulative materials. With a higher thermal diffusivity (meaning a higher thermal conductivity relative to the material's specific heat capacity and density), the temperature of such polymeric foams may tend to rise faster, such that heat propagates faster therethrough with continued heating. Other polymeric and elastomeric materials may have a lower thermal diffusivity than polymeric foams but tend to have higher thermal conductivities. Additionally, heat concentrated on one portion of such traditional thermally-insulative materials may not be distributed across the surface thereof, accelerating heat transfer through the material's thickness to the surface of the component it is designed to protect. As such, traditional thermally-insulative materials may not provide a level of thermal protection desired in some applications.

Furthermore, in some systems the thermally-insulative material may be subject to tight space constraints. Because traditional thermally-insulative materials are usually relatively thick and/or rigid, and such constraints may limit the amount traditional thermally-insulative material that can be included in the system—further limiting the thermal protection afforded by the material—or may render such materials unusable in the system. Compounding these limitations, polymers, elastomers, and foams often have a relatively high coefficient of thermal expansion, rendering the space constraints more restrictive for these materials when heated.

### SUMMARY OF THE INVENTION

A discovery has been made that provides a solution to at least one or more of the aforementioned problems associated with providing thermal protection to articles of manufacture, substrates, or systems (e.g., electric battery systems). In one aspect, it was discovered that a laminate comprising a flame-retardant layer having a flammability rating compliant with at least one flammability standard (e.g., UL94 5VB or UL94 5VA rating) and a porous, thermally-insulative (e.g., aerogel) layer can provide good thermal protection properties to the article of manufacture, substrate, or system (article of manufacture, substrate, or system can be used interchangeably throughout this specification). In such a laminate, synergies between the flame-retardant layer and the porous, thermally-insulative layer can provide for thermal protection of a substrate—in terms of heating rate and/or equilibrium temperature of the substrate—beyond that which might have been expected from the sum of those parts, especially at low thicknesses for the porous, thermally-insulative layer (e.g., less than 0.5 mm). Without wishing to be bound by any particular theory, it is believed that a porous, thermally-insulative layer, with its low thermal conductivity and low thermal diffusivity, effectively delays heat transfer from the flame-retardant layer and into the substrate.

By way of example, laminates of the present invention, when attached to a surface of a substrate, can be capable of maintaining the temperature of the substrate (e.g., surface temperature of the substrate) at 500° C. or less when the laminate is exposed to a temperature greater than 500° C., preferably 500° C. to 1,500° C., or more preferably 700° C. to 1,200° C., for 1 minute to 90 minutes, preferably for at least 5 minutes. This is advantageous in that it provides, for example, more time before the substrate (e.g., electric vehicle battery system) reaches a temperature in which the substrate may fail. This can be particularly advantageous when used to protect electric vehicle battery systems, as it can provide occupants of the vehicle more time to exit the vehicle after an accident and prior to having the electric vehicle battery catch fire, explode, and/or release toxic chemicals. It can also provide more time for first responders (e.g., fire department) to extinguish the flames before the electric vehicle battery catches fire, explodes, and/or releases toxic chemicals. Notably, the laminates of the present invention can be relatively thin (e.g., less than or equal to 25.4 millimeters (mm), 20 mm, 15 mm, 10 mm, 5 mm, 3 mm, 2 mm, 1 mm, 0.5 mm, 0.4 mm, 0.3 mm, 0.2 mm, 0.1 mm, or less) and/or can be relatively flexible (e.g., can be rolled up (see, e.g., FIG. 9) and/or have a bend radius. An advantage of the flexibility of the laminates of the present invention is that they can be used in tight-space-constraint applications (e.g., electric vehicle battery systems and battery packs).

Laminates of the present invention can also be configured to mitigate ejecta, such as that generatable from a battery thermal runaway event, by including a (e.g., fibrous) reinforcing layer, a (e.g., a fibrous, metallic, or ceramic) ejecta-mitigating layer, and/or reinforced (e.g., by fibers) flame-retardant layer(s), porous, thermally-insulative layer(s), and/or the like.

In one aspect of the present invention, there is disclosed a laminate comprising a flame-retardant layer and a porous material layer (e.g., a foam layer or an aerogel layer, preferably an aerogel layer). The laminate can have opposing front and back surfaces, and the flame-retardant layer can—but need not—define at least a majority of the front surface. The laminate can have a thickness of less than or equal to 25.4 millimeters (mm), 24 mm, 23 mm, 22 mm, 21 mm, 20 mm, 19 mm, 18 mm, 17 mm, 16 mm, 15 mm, 14 mm, 13 mm, 12 mm, 11 mm, 10 mm, 9 mm, 8 mm, 7 mm, 6 mm, 5 mm, 4 mm, 3 mm, 2 mm, 1 mm, 0.9 mm, 0.8 mm, 0.7 mm, 0.6 mm, 0.5 mm, 0.4 mm, 0.3 mm, 0.2 mm, 0.1 mm, or any range therein. In other aspects, the laminate can have a thickness of greater than 25.4 mm (e.g., 26, 27, 28, 29, 30, 35, 40, 45, 50, 55, 60, 65, 70, 75, 80, 85, 90, 95, or 100 mm or more or any range therein). In certain preferred aspects, the laminate has a thickness of 0.3 to 10 mm, 0.3 to 5 mm, or 0.3 mm to 3 mm. In certain aspects, the flame-retardant layer has a thickness of 0.05 mm to 0.8 mm. In certain aspects, the porous layer (e.g., aerogel layer) has a thickness of 0.05 mm to 1.0 mm (or any number or range therein such as 0.1, 0.2, 0.3, 0.4, 0.5, 0.6, 0.7, 0.8, 0.9 mm), preferably 0.05 mm and 0.254 mm.

In some aspects, the flame-retardant layer is not electrically insulative. In other aspects, the flame-retardant layer is electrically insulative. In some aspects, the flame-retardant layer and/or the entire laminate meets a plastic flammability standard. In some specific aspects, the plastic flammability standard is UL94 5VA or UL94 5VB. In a particular aspect, the flame-retardant layer comprises fibers (e.g., woven and/or non-woven fibers) and/or one or more of metal hydroxides, organophosphates, alumina hydroxide, inorganic fillers, and/or metal oxides. In some aspects, the flame-retardant layer can be halogen-free. In some aspects, the flame-retardant layer can include a silicate (e.g., a phyllosilicate). In some particular aspects, the silicate can include a mica. The flame-retardant layer can include at least 90% by weight, based on the total weight of the flame-retardant layer, of the silicate, preferably mica. In some aspects, the flame-retardant layer comprises a ceramic. The ceramic can include an inorganic and/or nonmetallic material (e.g., clay, kaolinate, aluminum oxide, silicon carbide, tungsten carbide, etc.) that can be subjected to high temperatures. In some aspects, the ceramic can include metal oxides or non-metal oxides or a combination thereof. In some aspects, the ceramic can include alumina, beryllia, ceria, zirconia, carbide, boride, nitride, or silicide, or any combination thereof. In some aspects, the flame-retardant layer can include at least 90% by weight, based on the total weight of the flame-retardant layer, of the ceramic.

In some aspects, the porous layer is an aerogel layer. In some aspects, the aerogel layer comprises an organic polymer. In some aspects, the organic polymer is a thermoplastic polymer. In some aspects, the thermoplastic polymer is a polymide, a polystyrene, a polyester, a polyamide, a polyether, a polyurethane, an acrylic polymer, a polyurea, a polypyrrole, a polythiophene, a polyaniline, an acrylic polymer, a vinyl polymer, a polysiloxane, a polysulfide, a polycarbonate, or copolymers, or a mixture thereof. In preferred embodiments, the thermoplastic polymer is polyimide, polyamic amide, or a mixture or copolymer thereof. In particular aspects, the aerogel layer comprises at least 50%, 60%, 70%, 80%, 90%, or 95% of the thermoplastic polymer, preferably polyimide or polyamic amide. In other aspects, the polymeric aerogel layer comprises less than 50%, 40%, 30%, 20%, 10%, 5%, or less of the thermoplastic polymer, preferably polymide or polyamic amide. In some aspects, the aerogel layer has a decomposition temperature that is greater than or equal to 400° C., preferably from 400° C. to 600° C.

The laminates of the present invention can include one or more adhesive layers. The one or more adhesive layers can be coupled to the porous layer. In one aspect, a first adhesive layer is disposed between the flame-retardant layer and the porous layer. The first adhesive layer can have a melting temperature or a decomposition temperature that is greater than 500° C., preferably greater than 600° C. In another aspect, a second adhesive layer can be disposed on the back surface of the porous layer (the surface further away from the flame-retardant layer). The first and/or second adhesive layer can be a pressure sensitive adhesive layer that is capable of affixing the back surface of the porous layer to a substrate. Prior to use, a releasable or peelable liner layer can be disposed on the second adhesive layer. In certain aspects, the second adhesive layer can have a melting temperature or a decomposition temperature that is greater than 500° C., preferably greater than 600° C. In particular aspects, the adhesive layer(s) can include a silicone adhesive compound and/or an epoxy compound.

The laminates of the present invention can include one or more heat-dispersing layers. In some aspects, the one or more heat-dispersing layers can have a thermal conductivity of at least 15 W/m·K, preferably 15 W/m·K to 2,500 W/m·K. In some aspects, the one or more heat-dispersing layers can include a metal or a graphite or a combination thereof. The metal or the graphite can have a thermal conductivity of at least 15 W/m·K, preferably 15 W/m·K to 2,500 W/m·K. In some aspects, the metal can include copper, aluminum, molybdenum, tungsten, rhenium, tantalum, niobium, stainless steel, nickel, or an alloy thereof. In some aspects, the one or more heat-dispersing layers can include at least 30%, 40%, 50%, 60%, 70%, 80%, 90%, 95%, 96%, 97%, 98%, 99% or more, by weight, based on the total weight of the heat-dispersing layer, of the metal and/or graphite. In some aspects, the one or more heat-dispersing layers can have a thickness of 0.001 mm to 0.4 mm, preferably from 0.01 mm to 0.05 mm, or any range or number therein (e.g., 0.02, 0.03, 0.04, 0.05, 0.06, 0.07, 0.08, 0.09, 0.1, 0.2, or 0.25 mm).

In some aspects, the one or more heat-dispersing layers can be coupled to the flame-retardant layer and/or to the porous layer. In some aspects, the one or more heat-dispersing layers can be disposed between the flame-retardant layer and the porous layer. In some aspects, a first adhesive layer can be disposed between the flame-retardant layer and the heat-dispersing layer, and/or a second adhesive layer can be disposed between the heat-dispersing layer and the porous layer. In some aspects, an adhesive layer is not disposed between the flame-retardant layer and the porous layer. In some aspects, the first adhesive layer can be in direct contact with the flame-retardant layer and with the heat-dispersing layer, and the second adhesive layer can be in direct contact with the heat-dispersing layer and with the porous layer. In some aspects, a third adhesive layer, and, optionally, a liner layer can be used, wherein the third adhesive layer is disposed between the porous layer and the optional liner layer. In some aspects, the third adhesive layer can be in direct contact with the porous layer and the optional liner layer. In some aspects, the first, second, third, or other adhesive layers can each: (1) have a melting temperature or a decomposition temperature that is greater than 500° C.; (2) comprise a pressure-sensitive adhesive; and/or (3) comprise a silicone adhesive compound and/or an epoxy compound.

In some aspects, any one of, any combination of, or all of the flame-retardant layer, the heat-dispersing layer, the porous layer, the first, second, third, or other adhesive layer, the reinforcing layer, and/or ejecta-mitigating layer (the latter two being introduced below) can be perforated. In some aspects, the perforations can be helpful to allow any gases (e.g., from evaporation or boiling of the adhesive layer) to be removed from the laminate. In some aspects, the size of the perforations are nanometers, micrometers, or millimeters. In some aspects, the pattern of the perforations can be random, grid-like, circular like, etc. In some particular embodiments, the pattern is grid-like. Without wishing to be bound by theory, it is believed that perforations can be helpful in the event that the adhesive layer(s), when subjected to elevated temperatures or reduced pressure, off-gas. Allowing for off-gassing can be helpful to avoid bubbling and/or delamination of the aerogel and/or flame-retardant layers.

The laminates of the present invention can include one or more reinforcing layers. In some aspects, the one or more reinforcing layers can be attached to at least a portion of the flame-retardant layer and/or comprised in at least a portion of a volume of the flame-retardant layer. In some aspects, the one or more reinforcing layers can include fibers. Non-limiting examples of fibers include glass fibers, carbon fibers, aramid fibers, thermoplastic fibers, thermoset fibers, ceramic fibers, basalt fibers, rock wool fibers, steel fibers, or cellulosic fibers, or any combination thereof. In some aspects, the fibers are non-woven fibers or are woven fibers. Such reinforcing layers, in addition to increasing the structural integrity of their laminates in general, can help mitigate ejecta that might occur during, for example, a battery thermal runaway event.

Indeed, during battery thermal runaway, heated ejecta can be produced by a failed battery that can degrade any thermal protection provided to the battery and/or adjacent components (e.g., batteries), potentially leading to a chain reaction of failed components. It can therefore be advantageous to guard against such ejecta, as some of the present laminates do through including (e.g., fiber-reinforced) reinforcing layers, reinforced (e.g., by fibers) flame-retardant and/or porous layers, and/or (e.g., fibrous, metallic, or ceramic) ejecta-mitigating layers. In some aspects, such an ejecta-mitigating layer can comprise at least 50%, such as at least 60, 70, 80, or 90% of a metal. That metal can include, for instance, titanium stainless steel, nickel, molybdenum, and/or tantalum. In some aspects, such an ejecta-mitigating layer can comprise fibers, such as any of the fibers described above for a reinforcing layer, which are preferably woven but can be non-woven. An ejecta-mitigating layer, in some of the present laminates, can define at least a majority of—up to and including all of—a front surface of a laminate.

Also disclosed in the context of the present invention is an apparatus comprising one or more laminates of the present invention. The laminate(s) can be coupled to the apparatus such that the front surface of a first one of the laminate(s) is disposed further from the apparatus than is the rear surface of the first laminate. The apparatus can be any type of apparatus. In preferred aspects, the apparatus is one that can potentially be subjected to elevated temperatures (e.g., greater than 500° C.) during use. One example is a battery. In a preferred aspect, the battery can be an electric vehicle battery system or battery pack. The battery can be a secondary/rechargeable battery (e.g., a lithium-ion battery or a nickel-metal hydride battery). The vehicle can include one or more wheels and one or more electric motors, each configured to rotate at least one of the wheels. The battery can be in electrical communication with at least one of the electric motor(s). In another example, the apparatus can be a busbar for a battery. The busbar can be in electrical communication with the battery. A laminate of the present invention can be coupled to the busbar such that the front surface of the laminate is disposed further from the busbar than is the rear surface of the laminate.

In some aspects, the apparatus can be a compression pad, a battery cell, a battery module, a battery pack, or a battery box. A compression pad, which can also be referred to as a battery pad cushion, can be positioned between battery cells to help withstand dimensional changes to the cells during charging and/or use of the cells. Compression pads can allow for sufficient pressure to be applied to a battery pack to maintain thermal and/or electrical connections, while also allowing for tolerance and/or expansion when battery cells are charged or exposed to extreme temperatures. In some aspects, the compression pad can include compressible material. In some aspects, the compressible material can be a foam (e.g., a polyurethane foam or a silicone foam). In some aspects, the compression pad is positioned between a first battery cell and a second battery cell. The laminates of the present invention can cover a portion of, a majority of, or all of an outer surface of a compression pad.

In some aspects, the apparatus can be a battery cell. A battery cell can be charged to provide electrical energy (e.g., supplying electrical energy to an electric motor) and can be discharged when in use or when exposed to extreme temperatures or when remaining in a latent state. A plurality of battery cells can be positioned next to each other, and compression pads can be positioned between each battery cell. The laminates of the present invention can cover a portion of, a majority of, or all of an outer surface of a battery cell.

In some aspects, the apparatus can be a battery module. The battery module can include a plurality of battery cells. The laminates of the present invention can cover a portion of, a majority of, or all of an outer surface of a battery module.

In some aspects, the apparatus can be a battery pack. The battery pack can include a plurality of battery modules. The laminates of the present invention can be positioned between battery modules of a battery pack. The laminates of the present invention can cover a portion of, a majority of, or all of an outer surface of a battery pack.

In some aspects, the apparatus can be a battery box or battery casing or container. The battery box or container can enclose a portion of, a majority of, or all of a battery pack. A battery box can include an outer surface, an inner surface, and an inner volume. Laminates of the present invention can cover at least a portion of, a majority of, or all of the outer surface, at least a portion, a majority of, or all of the inner surface, or both, of the battery box. In some preferred aspects, at least a portion of, a majority of, or all of the inside surface of the battery box is covered with one or more laminates of the present invention. In some aspects, the inner volume of the battery box includes compression pad, the battery cell, the battery module, or the battery pack, or any combination thereof. In some aspects, the compression pad, the battery cell, the battery module, the battery pack, and/or the battery box is comprised in a vehicle, the vehicle comprising one or more electric motors. In some aspects, the vehicle can be an automobile, an aircraft, a train, a watercraft, or a spacecraft.

In some aspects, the apparatus can be a cable. The cable can have a length and a width. The length can be longer than the width. In some aspects, the cable can be electrically-conductive. In some aspects, the cable can have an electrically-conductive portion and an electrically-insulative portion. In some aspects, the electrically-insulative portion can encompass a portion of, a majority of, or all of the electrically-conductive portion. In some aspects, the electrically-conductive portion can include a conductive metal (e.g., copper, gold, platinum, aluminum, steel, etc.). In some aspects, the cable can include a diameter of 0.0001 inches to 10 inches, preferably 0.001 inches to 1 inch, or any range or number therein (e.g., 0.0001, 0.0002, 0.0003, 0.0004, 0.0005, 0.0006, 0.0007, 0.0008, 0.0009, 0.001, 0.002, 0.003, 0.004, 0.005, 0.006, 0.007, 0.008, 0.009, 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 2, 3, 4, 5, 6, 7, 8, 9, or 10 inches in diameter). In certain aspects, the cable can be comprised in a missile, rocket, artillery, manned aircraft, unmanned aircraft, terrestrial vehicle, or sea vehicle. In certain aspects, the vehicle can be a spacecraft or an aircraft.

Also disclosed in the context of the present invention is a method of thermally protecting an apparatus with any one of the laminates of the present invention. The method can include coupling the laminate to a surface of the apparatus. The coupling can be made via an adhesive. The laminate can be positioned relative to the apparatus such that the front surface of the laminate is disposed further from the apparatus than the rear surface of the laminate. The laminates of the present invention are capable of maintaining the temperature of the apparatus at 500° C. or less when the front surface of the laminate is exposed to a temperature greater than 500° C., preferably 500° C. to 1,500° C. (or 600, 700, 800, 900, 1,000, 1,200, 1,300, 1,400° C. or any range therein), or more preferably 700° C. to 1,200° C. (or 800, 900, 1,000, or 1,100° C. or any range therein), for 1 minute to 90 minutes (or 2, 3, 4, 5, 10, 15, 20, 25, 30, 35, 40, 45, 50, 60, 70, 80, or 90 minutes or any range therein), preferably for at least 5 minutes.

The term “aerogel” refers to a class of materials that are generally produced by forming a gel, removing a mobile interstitial solvent phase from the pores, and then replacing it with a gas or gas-like material. By controlling the gel and evaporation system, density, shrinkage, and pore collapse can be minimized. Aerogels of the present invention can include macropores, mesopores, and/or micropores. In preferred aspects, the majority (e.g., more than 50%) of the aerogel's pore volume can be made up of macropores. In other alternative aspects, the majority of the aerogel's pore volume can be made up of mesopores and/or micropores such that less than 50% of the aerogel's pore volume is made up of macropores. In some embodiments, the aerogels of the present invention can have low bulk densities (about 0.75 g/cm³ or less, preferably about 0.01 g/cm³ to about 0.5 g/cm³), high surface areas (generally from about 10 m²/g to 1,000 m²/g and higher, preferably about 50 m²/g to about 1000 m²/g), high porosities (about 20% and greater, preferably greater than about 85%), and/or relatively large pore volumes (more than about 0.3 mL/g, preferably about 1.2 mL/g and higher).

The presence of macropores, mesopores, and/or micropores in the aerogels of the present invention can be determined by mercury intrusion porosimetry (MIP) and/or gas physisorption experiments. The MIP test can be used to measure mesopores and macropores (i.e., American Standard Testing Method (ASTM) D4404-10, Standard Test Method for Determination of Pore Volume and Pore Volume Distribution of Soil and Rock by Mercury Intrusion Porosimetry). Gas physisorption experiments can be used to measure micropores (i.e., ASTM D1993-03 (2008) Standard Test Method for Precipitated Silica-Surface Area by Multipoint BET Nitrogen).

A material's “decomposition temperature” is a temperature at which 2%, 5%, or 10% of a sample of the material, when heated in an environment raised to the temperature, decomposes. The decomposition temperature can be measured by placing the sample in a thermogravimetric analyzer (TGA), heating the sample from ambient temperature in the TGA (e.g., at a rate of 10° C./min), and recording the temperature at which the sample's mass is 2%, 5%, or 10% lower than its initial mass as its decomposition temperature.

The term “coupled” is defined as connected, although not necessarily directly, and not necessarily mechanically. Two items that are “coupled” may be unitary with each other or may be connected to one another via one or more intermediate components or elements.

The terms “a” and “an” are defined as one or more unless this disclosure explicitly requires otherwise.

The term “substantially” is defined as largely, but not necessarily wholly, what is specified (and includes what is specified; e.g., substantially 90 degrees includes 90 degrees, and substantially parallel includes parallel), as understood by a person of ordinary skill in the art. In any disclosed embodiment, the terms “substantially,” “approximately,” and “about” may be substituted with “within 10% of” what is specified.

The phrase “and/or” means and or or. To illustrate, A, B, and/or C includes: A alone, B alone, C alone, a combination of A and B, a combination of A and C, a combination of B and C, or a combination of A, B, and C. In other words, “and/or” operates as an inclusive or.

The terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and containing”) are open-ended linking verbs. As a result, an apparatus that “comprises,” “has,” “includes,” or “contains” one or more elements possesses those one or more elements, but it is not limited to possessing only those one or more elements. Likewise, a method that “comprises,” “has,” “includes,” or “contains” one or more steps possesses those one or more steps, but it is not limited to possessing only those one or more steps.

The laminates of the present invention can “comprise,” “consist essentially of,” or “consist of” particular ingredients, components, compositions, etc. disclosed throughout the specification. With respect to the transitional phrase “consisting essentially of,” in one non-limiting aspect, a basic and novel characteristic of the laminates of the present invention is their ability to thermally protect a substrate over time when the substrate is subjected to temperatures that can cause the substrate to fail (e.g., catch fire, explode, break apart, deform, etc.).

The feature or features of one embodiment may be applied to other embodiments, even though not described or illustrated, unless expressly prohibited by this disclosure or the nature of the embodiments.

Some details associated with the embodiments described above and others are described below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate identical structures. Rather, the same reference numbers may be used to indicate similar features or features with similar functionalities, as may non-identical reference numbers.

FIGS. 1A and 1B are cross-sectional views of an embodiment of the present laminates having a flame-retardant layer and a single aerogel layer (FIG. 1A) or a flame-retardant layer and two aerogel layers (FIG. 1B) attached to a substrate surface.

FIG. 2 is a cross-sectional view of another embodiment of the present laminates having a liner layer that is removably disposed on an adhesive layer of the laminate, the liner layer defining at least a portion of the back surface of the laminate.

FIG. 3 is a cross-sectional view of another embodiment of the present laminates having two flame-retardant layers disposed on opposing sides of one or more-two, as shown-aerogel layers.

FIG. 4 is a cross-sectional view of another embodiment of the present laminates having a reinforcing layer attached to a flame-retardant layer of the laminate.

FIG. 5 is a cross-sectional view of another embodiment of the present laminates having a heat-dispersing layer disposed between a flame-retardant layer of the laminate and an aerogel layer of the laminate.

FIGS. 6A-6C are cross-sectional views of other embodiments of the present laminates, each including one or more ejecta-mitigation layers.

FIG. 7 is a cross-sectional view of another embodiment of the present laminates including a titanium layer.

FIG. 8 is a cross-sectional view of another embodiment of the present laminates including a vinyl layer.

FIG. 9 is a perspective view of a roll of an embodiment of the present laminates.

FIG. 10 is a schematic of a vehicle having a battery that includes one or more embodiments of the present laminates.

FIG. 11A is a schematic view of a cable that includes one or more embodiments of the present laminates.

FIG. 11B is a cross-sectional schematic view of the cable of FIG. 11A, taken along line 11B-11B of FIG. 11A.

FIG. 12 is a schematic of a set-up to test the thermal and flame properties of the present laminates.

FIG. 13 is a schematic of a laminate used in the testing set-up of FIG. 12.

FIG. 14 shows thermal profiles of a control (no barrier on copper substrate), a flame-retardant barrier (layer) on the copper substrate, a thermally-insulative layer on the copper substrate, a laminate of the present invention (one thermally-insulative layer and one flame-retardant layer) on the copper substrate, and another laminate of the present invention (two thermally-insulative layers and one flame-retardant layer) on the copper substrate.

FIG. 15 is another schematic of a set-up to test the thermal and flame properties of the present laminates.

FIGS. 16 and 17 show thermal profiles of some of the present laminates.

FIG. 18 shows thermal profiles of some of the present laminates adhered to a low carbon steel plate, compared to the thermal profile of an unprotected low carbon steel plate.

FIG. 19 shows thermal profiles of some of the present laminates adhered to a carbon fiber composite plate compared to the thermal profile of an unprotected carbon fiber composite plate.

FIG. 20 is a backside-view of a carbon fiber composite plate that was protected on its frontside by one of the present laminates during exposure to a 1,000° C. flame for 25 min.

FIG. 21 shows a thermal profile of one of the present laminates adhered to an aluminum sheet substrate.

FIG. 22 is a backside-view of an aluminum sheet substrate that was protected on its frontside by one of the present laminates during exposure to a 1,000° C. flame for 25 min.

FIGS. 23 and 24 show thermal profiles of some of the present laminates that include an ejecta-mitigating layer and compare those thermal profiles to thermal profiles of some of the present laminates that do not include an ejecta-mitigating layer.

FIGS. 25 and 26 are images of the hot and cold sides of some of the present laminates that do not include an ejecta-mitigating layer after exposure to a 1,000° C. flame for 10 min.

FIGS. 27 and 28 are images of the hot and cold sides of some of the present laminates that do include ejecta-mitigating layers after exposure to a 1,000° C. flame for 10 min.

FIGS. 29-31 show thermal profiles of some of the present laminates that include one or more ejecta-mitigating layers.

FIGS. 32-36 are images of the hot and cold sides of some of the present laminates that include one or more ejecta-mitigating layers after exposure to a 1,000° C. flame for 10 min.

### DETAILED DESCRIPTION

The electrification of today's society provides technical advancements that offer alternatives to combustion engines. With these advancements, however, new challenges are presented. As an example, the use of electric vehicle battery systems in the transportation industry can reduce the reliance on gasoline as a fuel. However, these battery systems can potentially lead to a greater risk in explosions, fires, and/or release of toxic fumes if, for example, the battery systems are exposed to excessive heat (e.g., greater than 500° C.).

The present invention provides a solution to at least one of these issues. That solution includes a laminate material that can provide both good thermal protection and flexibility, both of which are desirable attributes to have in certain applications (e.g., electrical vehicle battery systems). In one aspect, the present invention provides a laminate comprising a flame-retardant layer having a flammability rating compliant with at least one plastic flammability standard (e.g., UL94 5VB or UL94 5VA rating) and a thermally-insulative layer. The laminates of the present invention, when attached to a surface of a substrate, can be capable of maintaining the temperature of the substrate (e.g., surface temperature of the substrate) at 500° C. or less when the laminate is exposed to a temperature greater than 500° C., preferably 500° C. to 1,500° C., or more preferably 700° C. to 1,200° C., for 1 minute to 90 minutes, preferably for at least 5 minutes.

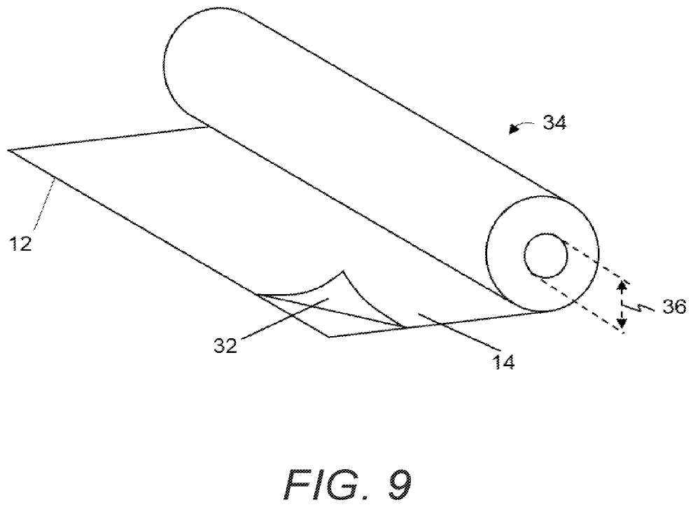

The laminates of the present invention can also be thin (e.g., a thickness of equal to or less than 25.4 millimeters (mm), 20 mm, 15 mm, 10 mm, 5 mm, 3 mm, 2 mm, 1 mm, 0.5 mm, 0.4 mm, 0.3 mm, 0.2 mm, 0.1 mm, or any range therein) and flexible (e.g., they can be rolled up (FIG. 9)) and/or have a bend radius. The good thermal protection properties of the laminates of the present invention along with their thin and flexible characteristics allow the laminates to be used in tight-space constrained places as a cover or protective layer for batteries (e.g., electric vehicle batteries and battery systems having multiple batteries), battery busbars, and a wide range of other articles of manufacture.

In some instances, a failed battery (e.g., one that enters thermal runaway) may discharge ejecta in addition to heat. To guard against such ejecta, it can be beneficial to have reinforcement or ejecta-mitigation in a thermal-protection barrier (e.g., for adjacent components), lest the structural integrity of that barrier be compromised by the ejecta and allow heat breakthrough earlier than anticipated. Some of the present laminates address this need, too, by including one or more (e.g., fiber-reinforced) reinforcing layers, reinforced (e.g., by fibers) flame-retardant and/or thermally-insulative layers, and/or (e.g., fibrous, metallic, or ceramic) ejecta-mitigating layers.

### A. Thermal and Flame Barrier Protection Laminates

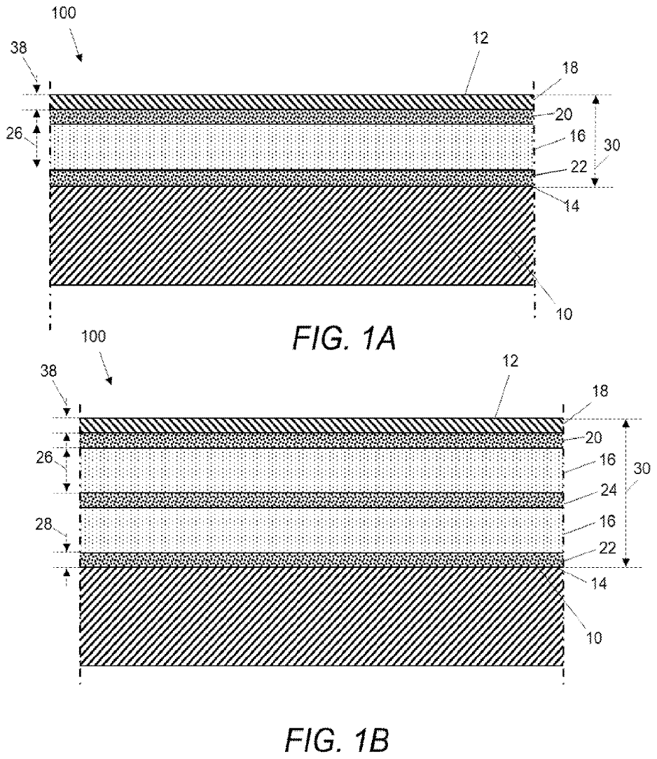

Referring to FIG. 1A and FIG. 1B, laminate 100 is shown. Laminate 100 can be attached to a surface of a substrate 10, with the laminate having opposing front and back surfaces, 12 and 14, respectively. Laminate 100 can include one or more thermally-insulative layers 16 (e.g., porous layers, such as aerogel layers), a flame-retardant layer 18 that optionally defines at least a portion (e.g., at least a majority, up to and including all) of front surface 12, and one or more adhesive layers 20, 22, and 24 for securing, e.g., thermally-insulative layer(s) 16 and flame-retardant layer 18 to one another. Thermally-insulative layer(s) 16 can include one such layer (FIG. 1A), two such layers (FIG. 1B), or more (e.g., 3, 4, 5, 6, 7, 8, 9, or more thermally-insulative layers), whether in laminate 100 or in others of the present laminates. Similarly, while laminate 100 is depicted as including one flame-retardant layer 18, others of the present laminates can include multiple flame-retardant layers (e.g., 2, 3, 4, 5, or more flame-retardant layers).

Accordingly, the number of adhesive layers 20, 22, and 24 can be 1, 2, 3, 4, 5, 6, 7, 8, 9, or more. To illustrate, an adhesive layer (e.g., 20) can adhere a flame-retardant layer 18 to a thermally-insulative layer 16, an adhesive layer (e.g., 24) can adhere thermally-insulative layers 16 together when there are multiple of the same (FIG. 1B), and/or the like. Further, an adhesive layer (e.g., 22) can define substantially all of back surface 14 of laminate 100 such that the laminate can be attached to substrate 10. To be clear, in some embodiments, laminate 100 need not have each or all of the above-described adhesive layer(s) (e.g., 20, 22, 24). For instance, in one embodiment, laminate 100 can include a single thermally-insulative layer (e.g., aerogel layer) 16, flame-retardant layer 18, adhesive layer 20, and adhesive layer 24.

Thermally-insulative layer(s) 16 can each have a thermal conductivity that is less than or equal to any one of, or between any two of, 0.05, 0.045, 0.040, 0.035, 0.030, 0.025, 0.020, 0.015, or 0.010 Watts per meter-Kelvin (W/m·K) (e.g., less than or equal to 0.025 W/m·K) and/or a thermal diffusivity that is less than or equal to any one of, or between any two of, 0.30, 0.20, 0.15, 0.125, 0.10, 0.09, 0.08, 0.07, 0.06, or 0.05 square millimeters per second (mm²/s) (e.g., less than or equal to 0.15 mm²/s or less than or equal to 0.10 mm²/s). As used herein, thermal conductivity and thermal diffusivity are each measured at 25° C. Additionally, each of thermally-insulative layer(s) 16 can be heat-resistant and/or have a low coefficient of thermal expansion such that laminate 100 can withstand heating when used and resist expansion for applications in which the laminate is subject to tight space constraints. For example, each of thermally-insulative layer(s) 16 can have a decomposition temperature that is greater than or equal to any one of, or between any two of, 400, 425, 450, 475, 500, 525, 550, 575, or 600° C. (e.g., greater than or equal to 450° C.) and/or a coefficient of thermal expansion (e.g., in at least one direction) that is less than or equal to any one of, or between any two of, 80, 75, 70, 65, 60, 55, 50, 45, 40, 35, 30, 25, 20, 15, 10, or 5 μm/m·K (e.g., less than or equal to 80 μm/m·K or less than or equal to 35 μm/m·K).

To achieve such properties, at least one—up to and including each—of thermally-insulative layer(s) 16 can comprise a layer of polymeric aerogel. The amount of polymeric aerogel can be at least 90% by weight of an organic polymer such as polyimide, polyaramid, polyurethane, polyurea, and/or polyester. Each polymeric aerogel layer can have micropores, mesopores, and/or macropores. Greater than or equal to any one of, or between any two of: 10%, 25%, 50%, 75%, or 95% of a pore volume of each aerogel layer can be made up of micropores, mesopores, and/or macropores (e.g., of micropores, of mesopores, of micropores and mesopores, or of macropores). An average pore diameter and/or median pore diameter of each aerogel layer can be greater than or equal to any one of, or between any two of: 50, 100,150, 200, 250, 300, 350, 400, 450, 500, 800, 1,000, 2,000, 3,000, 4,000, or 5,000 nm (e.g., the average pore diameter can be between 100 and 500 nm, and the median pore diameter can be between 250 and 600 nm). Materials of and processes for making layers of polymeric aerogels are explained in further detail below.

In some embodiments, for at least one (e.g., each) of thermally-insulative layer(s) 16, the aerogel layer can include reinforcing fibers, which can be dispersed throughout (e.g., as ordered (e.g., woven) or chopped or discontinuous fibers not arranged in a sheet) or embedded in (e.g., as a woven, nonwoven, or unidirectional sheet of fibers) the aerogel layer, optionally such that the volume of the fibers is greater than or equal to any one of, or between any two of, 0.1%, 10%, 20%, 30%, 40%, or 50% of the aerogel layer's volume. However, the aerogel layer(s) need not comprise fibers (e.g., to promote flexibility).

Suitable fibers include glass fibers, carbon fibers, aramid fibers, thermoplastic fibers, thermoset fibers, ceramic fibers, basalt fibers, rock wool fibers, steel fibers, cellulosic fibers, and/or the like. An average filament cross-sectional area of the fibers used for reinforcement can be greater than or equal to any one of, or between any two of, 7, 15, 30, 60, 100, 200, 300, 400, 500, 600, 700, or 800 μm²; for example, for fibers with a circular cross-section, an average diameter of the fibers can be greater than or equal to any one of, or between any two of, 3, 4, 5, 6, 7, 8, 9, 10, 11, 12, 13, 14, 15, 16, 17, 18, 19, 20, 21, 22, 23, 24, 25, 26, 27, 28, 29, or 30 μm (e.g., between 5 and 24 μm, such as between 10 and 20 μm or between 12 and 15 μm).

Non-limiting examples of thermoplastic polymers that can be used for polymeric reinforcing fibers include polyethylene terephthalate (PET), polycarbonate (PC), polybutylene terephthalate (PBT), poly(1,4-cyclohexylidene cyclohexane-1,4-dicarboxylate) (PCCD), glycol modified polycyclohexyl terephthalate (PCTG), poly(phenylene oxide) (PPO), polypropylene (PP), polyethylene (PE), polyvinyl chloride (PVC), polystyrene (PS), polymethyl methacrylate (PMMA), polyethyleneimine or polyetherimide (PEI) and their derivatives, thermoplastic elastomer (TPE), terephthalic acid (TPA) elastomers, poly(cyclohexanedimethylene terephthalate) (PCT), polyethylene naphthalate (PEN), polyamide (PA), polysulfone sulfonate (PSS), sulfonates of polysulfones, polyether ether ketone (PEEK), polyether ketone (PEKK), acrylonitrile butyldiene styrene (ABS), polyphenylene sulfide (PPS), co-polymers thereof, polyesters or derivatives thereof, polyamides or derivatives thereof (e.g., nylon), or blends thereof.

Non-limiting examples of thermoset polymers that can be used as a material for polymeric reinforcing fibers include unsaturated polyester resins, polyurethanes, polyoxybenzylmethylenglycolanhydride (e.g., Bakelite), urea-formaldehyde, diallyl-phthalate, epoxy resin, epoxy vinylesters, polyimides, cyanate esters of polycyanurates, dicyclopentadiene, phenolics, benzoxazines, co-polymers thereof, or blends thereof.

While each of thermally-insulative layer(s) 16 can include a layer of polymeric aerogel, in other embodiments at least one—up to and including each—of the thermally-insulative layer(s) can any suitable thermally-insulative material, such as a layer of fibers. At least one, up to and including each of thermally-insulative layer(s) 16 can also include a layer of fibers laminated to a layer of polymeric aerogel, optionally such that the layer of fibers is disposed closer to front surface 12 of laminate 100 than is the layer of aerogel. The fibers in a layer of fibers can be any of those described above for the aerogel fiber-reinforcement (e.g., glass fibers and/or basalt fibers) and can be arranged in a variety of fibrous structures. For example, the fibers can form a fiber matrix, as in felt, batting lofty batting, a mat, a woven fabric, a non-woven fabric. The fibers can be unidrectionally or omnidirectionally oriented.

In some embodiments, the fibers used as reinforcement in an aerogel layer or in a layer of fibers can have an average filament cross-sectional area from 5 μm² to 40,000 μm² and/or an average length of 20 mm to 100 mm.

To permit use of laminate 100 in applications having tight space constraints, each of thermally-insulative layer(s) 16 (e.g., aerogel layer(s)) can be relatively thin. For example, a thickness 26 (FIG. 1A) of at least one (e.g., each) of thermally-insulative layer(s) 16 can be less than or equal to any one of, or between any two of, 50, 25, 20, 15, 10, 5, 4, 3, 2, 1, 0.9, 0.8, 0.7, 0.6, 0.5, 0.4, 0.3, 0.2, 0.15, 0.1, or 0.05 mm (e.g., between 0.10 and 0.20 mm, such as 0.165 mm).

The combination of thermally-insulative layer(s) 16 and flame-retardant layer(s) 18 can mitigate heat and flame propagation for thermal and flame protection of substrate surface 10. Flame-retardant layer(s) 18 each include flame-retardant materials, optionally along with non-woven fibers, paper, and fillers. Flame-retardant materials include metal hydroxides, organophosphates, metal phosphates, nitrogen containing polymers, nitrogen-phosphorus compounds, talc, sulfonates or salts thereof, silica, a silicate (e.g., a mica, such as samica), hydrated oxides, organic polymers, nanoclays, organoclay, organic polymers, silicon-phosphorous-nitrogen compounds, metal oxides, a ceramic (e.g., a metal and/or non-metal oxide, alumina, beryllia, ceria, zirconia, carbide, boride, nitride, and/or silicide), and mixtures thereof. Non-limiting examples of metal hydroxides include alumina trihydrate, magnesium oxide and the like. Non-limiting examples of metal oxides include titanium oxide, aluminum oxide, zinc oxide, iron oxide magnesium oxide, calcium oxide, and the like. Non-limiting examples of phosphates include trimethyl phosphate, triethyl phosphate, tributyl phosphate, tri(2-ethylhexyl) phosphate, tributoxyethyl phosphate, monoisodecyl phosphate, 2-acryloyloxyethyl phosphate, trixylenyl phosphate, tris(2-phenylphenyl) phosphate, trinaphthyl phosphate, cresyldiphenyl phosphate, xylenyldiphenyl phosphate, diphenyl-2-methacrylolyloxyethyl phosphate, resorcinol bis(diphenyl phosphate), resorcinol bis(dixylenyl phosphate), resorcinol bis(dicresyl phosphate), hydroquinone bis(dixylenyl phosphate), bisphenol A bis(diphenyl phosphate), tetrakis(2,6-dimethylphenyl) 1,3-phenylenebisphosphate, pentaerythritol phosphate alcohol, oligomeric ethyl ethylene phosphate, tricresyl phosphate, trixylenyl phosphate, isopropylphenyl phosphate, tert-butylphenyl diphenyl phosphate, 2-ethylhexyl diphenyl phosphate, isodecyl diphenyl phosphate, butyl diphenyl phosphate, dibutyl phenyl phosphate, tributyl phosphate, tetraphenyl resorcinol diphosphate, and tetraphenyl bisphenol-A diphosphate. In some embodiments, flame-retardant layer(s) (e.g., 18) can include at least 90%, by weight, of a flame-retardant material, such as, for example, at least 90%, by weight, of a silicate, or at least 90%, by weight, of a ceramic.

Non-limiting examples of fillers include kaolin clay, talc, mica, calcium carbonate, alumina trihydrate, montmorillonite, smectite, bentonite, illite, chlorite, sepiolite, attapulgite, halloysite, vermiculite, laponite, rectorite, perlite, aluminum nitride, silicon carbide, boron nitride, and combinations thereof.

Flame-retardant layer(s) 18 can each meet plastic flammability standards (e.g., UL94 V-0, V-1, V-2, HB, 5VA, 5VB, and the like). A thickness 38 (FIGS. 1A and 1B) of a given flame-retardant layer 18 can be greater than any one of, or between any two of, 0.03, 0.04, 0.05, 0.10, 0.20, 0.30, 0.40, 0.50, 0.60, 0.70, 0.80, 0.90, 1.00, 1.20, 1.40, 1.60, 1.80, 2.00, 2.20, 2.40, 2.60, 2.80, 3.00, 3.20, 3.40, 3.60, 3.80, 4.00, 4.20, 4.40, 4.60, 4.80, 5.00 mm (e.g., from 0.03 mm to 5.0 mm). In some instances, a thickness of the flame-retardant layer ranges from 0.145 mm to 0.225 mm and has a UL94 5VA or a UL94 5VB, preferably UL94 5VA, flammability rating. Flame-retardant layer(s) 18 can be electrically insulative or non-electrically insulative.

Flame-retardant layer(s) 18 can each be a commercially-available product. Non-limiting examples of commercially flame-retardant tapes or papers suitable as a flame-retardant layer are those sold under the Unifrax brand (e.g., FyreWrap LiB Papers and Film), 3M® brand (e.g., 3M VHB tapes, 3M FRB papers), Scotch® brand, U-Line brand, and the like. In particular embodiments, Unifrax brand FyreWrap LiB Paper (e.g., FX70 and IN70), Unifrax brand Fyre Wrap LiB Film (e.g., C1554), 3M®'s Flame Barrier FRB-WT Series, 3M®'s Flame Barrier FRB-NT Series (e.g., FRB-BK, FRB-NT Laminate, FRB-NC Laminate, or FRB-NC Series) (3M, St. Paul, Minnesota) can be used.

Flame-retardant layer(s) 18 can each be reinforced. For example, the flame-retardant layer can include woven and/or nonwoven fibers. Non-limiting examples of fibers include aramid fibers, organic fibers, glass fibers, carbon fibers, thermoplastic fibers, thermoset fibers, basalt fibers, ceramic fibers, rock wool fibers, steel fibers, cellulosic fibers, and/or the like. In embodiments where the flame-retardant layer is fiber-reinforced, the fibers can be comprised in at least a portion of a volume of the flame-retardant layer in the form of, for example, a reinforcing layer.

As described above, when laminate 100 includes multiple thermally-insulative layers 16 and/or flame-retardant layers 18, the laminate can include multiple adhesive layers (e.g. adhesive layers 20, 22, and 24), with, optionally, an adhesive layer (e.g., 22) defining at least a portion of back surface 14 to permit adhesion to substrate 10 as previously described above. Such adhesive layers (e.g., 20, 24) can bond-together the thermally-insulative layer(s) 16, flame-retardant layer(s) 18, other layer(s) as described below, or a combination of such layers. To do so, each of the adhesive layers can be disposed between and in contact with adjacent ones of the other laminate layers (e.g., between two of thermally-insulative layers 16 and/or between one of the thermally-insulative layers and a flame-retardant layer).

As one example, two thermally-insulative layers 16 can be bonded together and bonded to a flame-retardant layer 18. In another example, a stack of a first flame-retardant layer 18, first thermally-insulative layer 16, second flame-retardant layer 18, and second thermally-insulative layer 16, can be bonded together with adhesive layers (e.g., 20, 22, 24). To illustrate with FIG. 1B, an adhesive layer 20 can be disposed between and in contact with a flame-retardant layer 18 and one of thermally-insulative layers 16, and an adhesive layer 24 can be disposed between and in contact with two of the thermally-insulative layers. To facilitate adhesion without adding substantial thickness to a laminate, a thickness 28 of at least one (e.g., each) of adhesive layer(s) (e.g., adhesive layers 20, 22, and 24) can be less than or equal to any one of, or between any two of, 5.0, 4.5, 4.0, 3.5, 3.0, 2.5, 2.0, 1.5, or 1.0 mm (e.g., between 1.5 and 3.5 mm).

Adhesive layers (e.g., 20, 22, and 24) can be the same or different material; for example, silicone adhesive compounds, acrylic adhesive compounds, rubber adhesive compounds, phenolic compounds, cyanate esters compounds, epoxy resin compounds, and/or the like. In certain aspects, the adhesive layers can be adhesives that can maintain adhesion at elevated temperatures (e.g., 500° C. or greater), non-limiting examples of which include FLEXcon Silicone Adhesive SA 6000 SA 9000D series (FLEXcon Company, Inc., Spencer, Massachusetts), Alamo Tapes Epoxy Adhesives (Alamotape, San Antonio, Texas), Avery FT 3010 (Avery Dennison Corporation, Painesville, Ohio), and Adhesive Applications S1001-01 (Adhesive Applications, Inc., Easthampton, Massachusetts).

At least one—up to and including each—of adhesive layer(s) (e.g., 20, 22, and 24) can include a pressure-sensitive adhesive, such as one that includes silicone, epoxy, acrylic, phenolic, cyanate esters, epoxy resin, and/or rubber and the like. Such a pressure-sensitive adhesive, when used for adhesive layer 22, may permit ready application of laminate 100 to surface 10 for thermal protection thereof (e.g., by simply pressing laminate 100 against the surface). However, at least one of the adhesive layer(s) can include a different type of adhesive, such as fluoropolymer films, polyimide films, and B-stage epoxies; examples include commercially-available adhesives such as FEP Film, Pyralux® HT, and Pyralux® GPL from DuPont™ and TSU510S-A from Toyochem Co., LTD. (Tokyo, Japan). With such other adhesives, bonding can be achieved by stacking one of the present laminate's (e.g, 100) layers and applying heat and/or pressure to the stack (e.g., with a press), optionally such that the temperature thereof exceeds the glass transition temperature of the adhesive layer(s). In some embodiments with multiple adhesive layers, some of the adhesive layers (e.g., 22) can include a pressure-sensitive adhesive and others (e.g., 20 and 24) can include another type of adhesive, like those listed above.

The composition of adhesive layer(s) (e.g., 20, 22, and/or 24) can mitigate the risk of delamination, such as through heat-resistance. For example, at least one (e.g., each) of the adhesive layer(s) can have a melting temperature or a decomposition temperature that is greater than or equal to any one of, or between any two of, 350, 375, 400, 425, 450, 500, 550, or 600° C. Additionally, if using a B-stage epoxy adhesive, at least one (e.g., each) of adhesive layer(s) 20, 22, and 24) can have a glass transition temperature or a melting point that is greater than or equal to any one of, or between any two of, 100, 150, 175, 200, 225, 250, or 275° C. The composition of adhesive layer(s) (e.g., 20, 22, and/or 24) can be flame-retardant.

With the above-described constructions, laminate 100 can provide thermal and flame protection in high-temperature and combustible environments. For example, a thermal diffusivity of laminate 100 can be less than or equal to any one of, or between any two of, 0.15, 0.125, 0.10, 0.09, 0.08, 0.07, 0.06, 0.05, or 0.04 mm²/s (e.g., less than or equal to 0.10 mm²/s, such as less than or equal to 0.075 mm²/s), thereby mitigating heat propagation therethrough. A flammability rating of laminate 100 can meet UL 94 requirements. For example, the laminate can inhibit flame spread at a temperature above 500° C. for at least 5 minutes such that it resists burning. The laminate can have a UL94 5VB or UL94 5VA rating. In some embodiments, the laminate can be compliant with FAR 25, Appendix F, Part 1.

Furthermore, while a total thickness (shown as 30 in FIGS. 1A and 1B) of laminate 100 can be less than or equal to 25.4 mm, the laminate can advantageously be relatively thin as described above, such as less than or equal to any one of, or between any two of, 25.4, 20, 15, 10, 5, 4, 3, or 2 mm (e.g., less than or equal to 10 mm or less than or equal to 0.3 mm). Such thinness may allow laminate 100 to be used in small spaces, such as those that are often in vehicles like electric or hybrid vehicles and/or electronic components, while still providing the above-described thermal and flame protection. Laminate 100 can thus provide better thermal and flame protection in size-constrained applications than traditional insulative/flame-retardant materials, which may not be able to meet or may sacrifice thermal or flame protection to meet the size constraints.

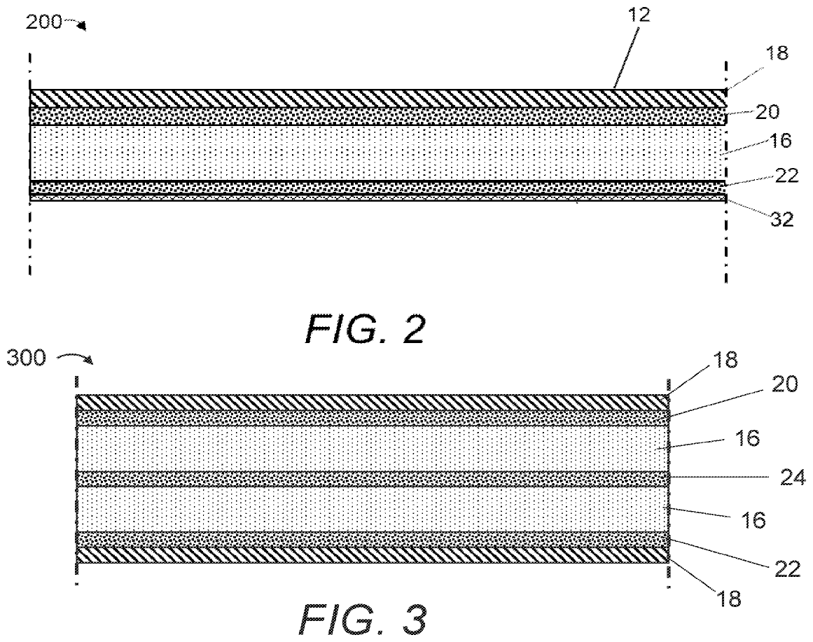

Referring additionally to FIG. 2, shown is laminate 200 that is substantially similar to laminate 100, the primary exception being that laminate 200 includes a liner layer 32. As shown, laminate 200 is not yet attached to a substrate surface 10. To protect second adhesive layer 22 before it is adhered to substrate surface 10 (e.g., against contaminants that may compromise its adhesiveness), liner layer 32 can be removably disposed on the second adhesive layer such that at least a portion (e.g., at least a majority, up to and including all) of back surface 14 of laminate 200 is defined by the liner layer. Liner layer 32 can include, for example, a polymeric film or a paper sheet and can be removed from second adhesive layer 22 by, for example, peeling it away from laminate 200.

Referring additionally to FIG. 3 and as described above, the present laminates can include multiple flame-retardant layers 18. In particular, FIG. 3's laminate 300 includes two flame-retardant layers 18. One of the flame-retardant layers 18 can be positioned on one side of thermally-insulative layer(s) 16, with the other of the flame-retardant layers positioned on the other side of the thermally-insulative layers. Flame-retardant layers 18 need not be of the same thickness; for instance, the flame-facing flame-retardant layer 18 can have a thickness that is greater than any one of, or between any two of 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, or 3.0 times (e.g., about 2.6 times) a thickness of flame-retardant layer 18 on the opposing side of thermally-insulative layer(s) 16. FIG. 3 also illustrates that an adhesive layer (e.g., 22) for securing the laminate to a substrate as well as a liner layer (e.g., 32) for that adhesive layer are each optional.

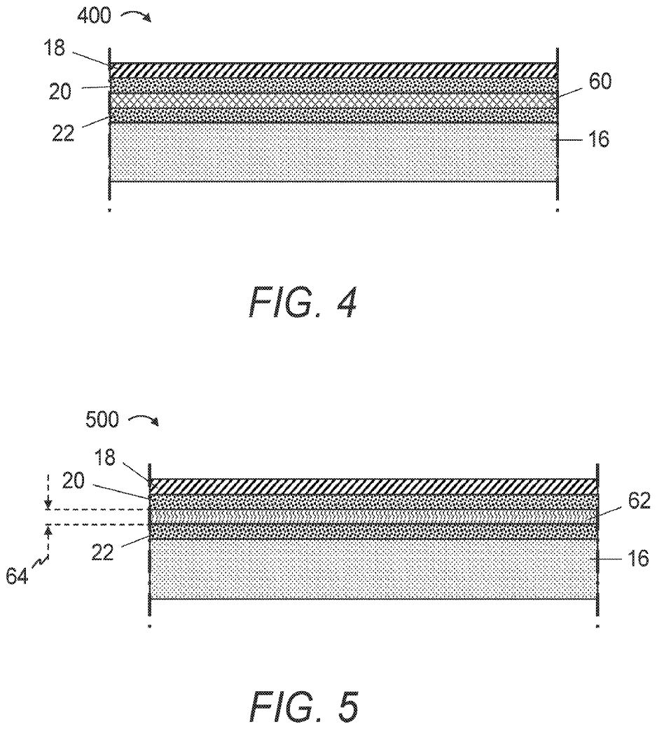

Additionally or alternatively, and referring to FIG. 4, some laminates, like laminate 400, include a reinforcing layer 60 that is separate, which can include fibers of the types described above, whether woven and/or nonwoven. More particularly, reinforcing layer 60 can be attached to at least a portion of flame-retardant layer 18, such as via an adhesive layer 20. Other laminates can include any suitable number of reinforcing layers (e.g., 60), which can each be disposed at any suitable location within the laminate. Such reinforcing layer(s), in addition to providing general reinforcement to a laminate, can facilitate address of ejecta that might be produced, e.g., during a battery thermal runaway event.

Referring now to FIG. 5, shown is a laminate 500 that is substantially similar to laminate 100, with the primary exception being that laminate 500 includes a heat-dispersing layer 62. Laminate 500 includes one heat-dispersing layer 62, which is disposed between flame-retardant layer 18 and aerogel layer 16. Nevertheless, others of the present laminates can include any suitable number of heat-dispersing layers (e.g., 62), which can be disposed at any suitable location within the laminate. Further, in laminate 500, heat-dispersing layer 62 is attached to both flame-retardant layer 18 and aerogel layer 16 via an adhesive layer, 20 and 22, respectively, but neither adhesive layer is required. And like any of the present laminates, laminate 500 can include an adhesive layer 24 for adhering the laminate to a substrate, which optionally can be protected by a liner layer (e.g., 32) before such adherence as described above.

Heat-dispersing layer 62 can comprise a thermally-conductive material, such as a metal (e.g., copper, aluminum, molybdenum, tungsten, rhenium, tantalum, niobium, stainless steel, nickel, or an alloy thereof), graphite, and/or the like. More particularly, heat-dispersing layer 62 can comprise at least 90%, by weight, of the thermally-conductive material, such as, for example, at least 90%, by weight, of a metal, or at least 90%, by weight, of graphite. Heat-dispersing layer 60 can have a thermal conductivity of at least 15 W/m·K, preferably from 15 W/m·K to 2,500 W/m·K. It can also have a melting point or decomposition temperature of at least 500° C., preferably, a melting temperature of at least 1,300° C., at least 1,600° C., at least 1,900° C., at least 2,200° C., at least 2,400° C., at least 2,700° C., at least 3,000° C., or at least 3,300° C. (e.g., and less than 3,800° C. or less than 3,600° C.). In general, such heat-dispersing layer(s) can mitigate the development of hot spots along underlying layer(s) in the laminate, and the attendant burning or charring of those underlying layers, by spreading heat from the environment along the laminate. A thickness 64 of heat-dispersing layer 62 can be greater than any one of, or between any two of: 0.001, 0.002, 0.004, 0.006, 0.008, 0.01, 0.02, 0.04, 0.06, 0.08, 0.10, 0.12, 0.14, 0.16, 0.18, 0.20, 0.22, 0.24, 0.26, 0.28, 0.30, 0.32, 0.34, 0.36, 0.38, and 0.40 mm (e.g., from 0.001 mm to 4 mm or from 0.01 mm to 0.08 mm).

While laminate 500 is depicted as including one thermally-insulative layer 16, as with others of the present laminates, laminate 500 can include multiple thermally-insulative layers 16, optionally connected by adhesive layers (e.g., 24). Further, laminate 500 as shown includes one fire-retardant layer 18, but other embodiments can include multiple fire-retardant layers 18, including one disposed above and one disposed below thermally-insulative layer(s) 16.

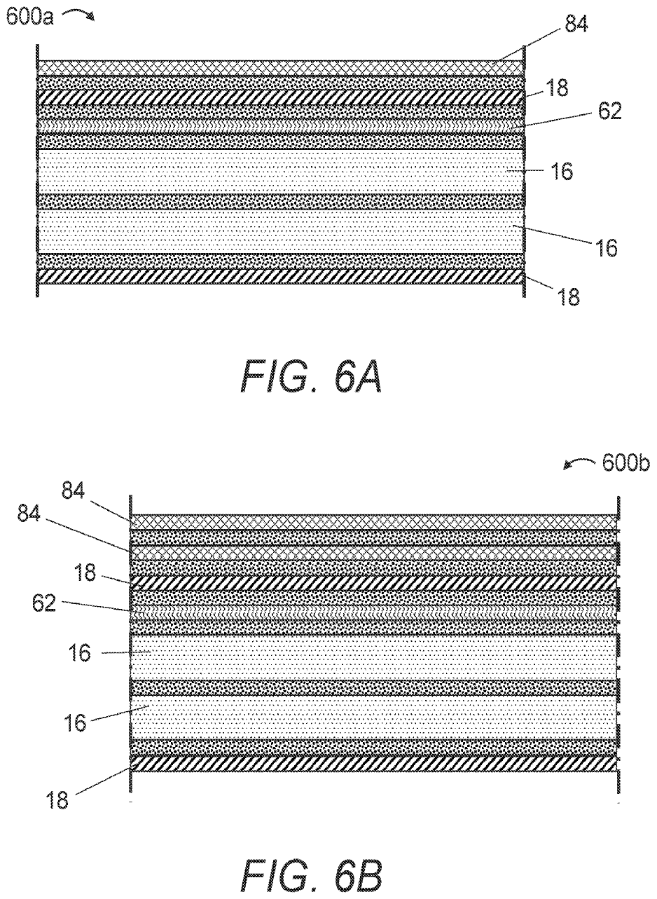

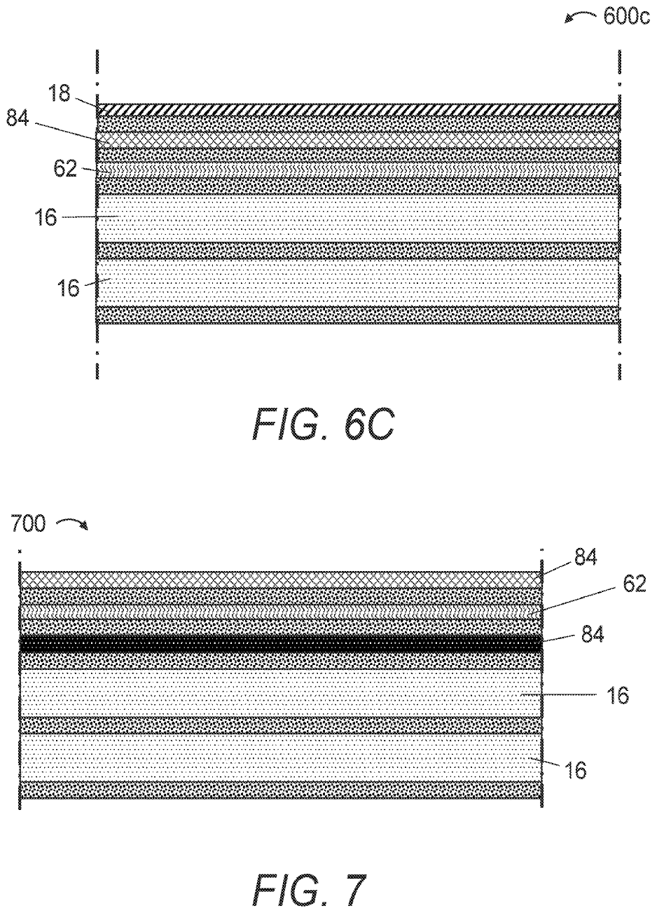

Referring now to FIGS. 6A-6C, some of the present laminates (600a-600c) can include one or more ejecta-mitigating layers 84 for addressing, for instance, ejecta produced during a battery thermal runaway event. Such ejecta-mitigating layer(s) 84 can include fibrous layers, and in that context, can be characterized as reinforcing layers. To that end, ejecta-mitigating layer(s) can include any of the fibers described above for a reinforcing layer (e.g., basalt or glass fibers), to specifically include silica-based fiberglass, fiberglass coated with vermiculite, high-silica-content fiberglass (e.g., quartz fiberglass), ceramic fibers (e.g., NEXTEL ceramic fibers 312, 440, 610, 729) (including aluminum-oxide fibers), rock wool, or carbon fibers, whether or not woven. Again, the present laminates may not include a bottom flame-retardant layer (e.g., FIG. 6C) and may not include a heat-dispersing layer (e.g., 62). And as with the porous, thermally-insulative layer(s) 16, multiple ejecta-mitigating layer(s) (FIG. 6B) may prove beneficial. While the biggest benefit might be obtained by the ejecta-mitigating layer being disposed above the heat-dispersing layer-when present-such is not required.

Beyond that, and referring additionally to FIG. 7's laminate 700, an ejecta-mitigating layer 84 can comprise a metal. That metal can have a melting point of above 1,000° C., preferably above 1,200° C. Such metals can include, for example, stainless steel, titanium, nickel, molybdenum, tantalum/or the like. Such layer(s) can reflect heat back toward the source and function as a heat-barrier. In a particular advantageous embodiment, one ejecta-mitigating layer 84 can be fiber-based, while the other can be metal-based. In that circumstance, it is preferable that the fiber-based ejecta-mitigating layer 84 is positioned closer to the flame-facing side than is the metal-based ejecta-mitigating layer 84 (FIG. 7). In any event, the present laminates can include any suitable number of ejecta-mitigating layers, whether fiber- and/or metal-based, (e.g., 1, 2, 3, 4, 5, 6, 7, 8, 9 or more) ejecta-mitigating layers, which can be positioned at any suitable location in the laminate.

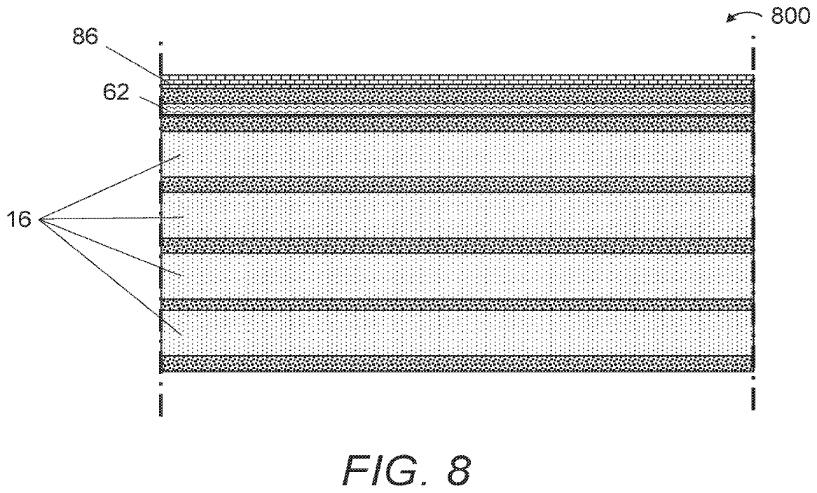

Referring now to FIG. 8, shown is laminate 800. Laminate 800, as with any other of the present laminates, can include a protective layer 86. Protective layer 86 can, for example, provide protection against the environment, including rain, wind, sun exposure, and/or the like. It can also provide protection against application-specific circumstances, including jet-fuel spray, electrical arcing, mechanical abrasion, and/or the like. Protective layer 86 can comprise, for example, plastics, glasses, or ceramics. Suitable thermoplastics include metals, polyester, PVC (“vinyl”), polyvinyl fluoride, polyvinylidene fluoride (PVDF), polyimide, aramid, polyethylene terephthalate (PET), polycarbonate (PC) family of polymers, polybutylene terephthalate (PBT), poly(1,4-cyclohexylidene cyclohexane-1,4-dicarboxylate) (PCCD), glycol modified polycyclohexyl terephthalate (PCTG), poly(phenylene oxide) (PPO polypropylene (PP), polyethylene (PE), polyvinyl chloride (PVC), polystyrene (PS), polymethyl methacrylate (PMMA), polyethyleneimine or polyetherimide (PEI) and their derivatives, thermoplastic elastomer (TPE), terephthalic acid (TPA) elastomers, poly(cyclohexanedimethylene terephthalate) (PCT), polyethylene naphthalate (PEN), 5 polyamide (PA), polysulfone sulfonate (PSS), sulfonates of polysulfones, polyether ether ketone (PEEK), polyether ketone ketone (PEKK), acrylonitrile butyldiene styrene (ABS), polyphenylene sulfide (PPS), co-polymers thereof, or blends thereof. Suitable thermoset plastics include polyaramid, polyimide, polybenzoxazole, polyurethane, or blends thereof.

Referring now to FIG. 9, the present laminates (e.g., 100-800) can be flexible. To illustrate, such a laminate can be capable of being disposed in a roll 34 having inner diameter 36 of less than or equal to any one of, or between any two of, 10 cm, 8 cm, 5 cm, 4 cm, 2 cm, 1 cm, 8 mm, 5 mm, 4 mm, 2 mm, or 1 mm without suffering permanent deformation. Such flexibility—even if not rising to the level of this example—can be provided by the materials of the laminate's thermally-insulative, flame-retardant, adhesive, and other (if present) layers and/or the relatively small thicknesses of those layers (e.g., those discussed above). When in roll 34, a portion of the laminate's front surface 12 can face a portion of its back surface 14.

In some embodiments, the laminate can protect an apparatus or substrate from temperatures greater than 500° C. For example, one of the present laminates can be positioned relative to the apparatus such that the flame-retardant layer is disposed further from the apparatus than the laminate's rear surface (e.g. back surface 14). When exposed to temperatures greater than 500° C. to 1,500° C. for a time of 1 to 90 minutes (preferably at least 5 minutes), the temperature of the apparatus does not exceed 500° C. during the time period. Exposure temperatures can range from 500° C. to 1500° C. or 700° C. to 1,200° C., or 500° C., 600° C., 700° C., 800° C., 900° C., 1000° C., 1100° C., 1200° C., 1300° C., 1400° C., 1500° C. or any range or value there between. Of course, the present laminates are also suitable for use in applications where they are exposed to lower temperatures (e.g., less than or equal to 100° C., 200° C., 300° C., or 400° C.) and/or exposed to any of the above temperatures for a shorter period of time (e.g., less than or equal to 1, 2, 3, 4, 5, 10, 15, 20, 25, 30, 40, 50, or 60 seconds).

Apparatuses in which such thermal protection is advantageous include, for example, batteries (e.g., lithium-ion batteries), busbars, and particularly electric or hybrid vehicles or electrical components that include batteries and electric motors that are subject to high-temperature environments. Surface (e.g., 10) to which one of the present laminates can be attached can be a surface of a battery such as lithium-ion battery. That surface can also be a busbar or non-electrically conductive materials.

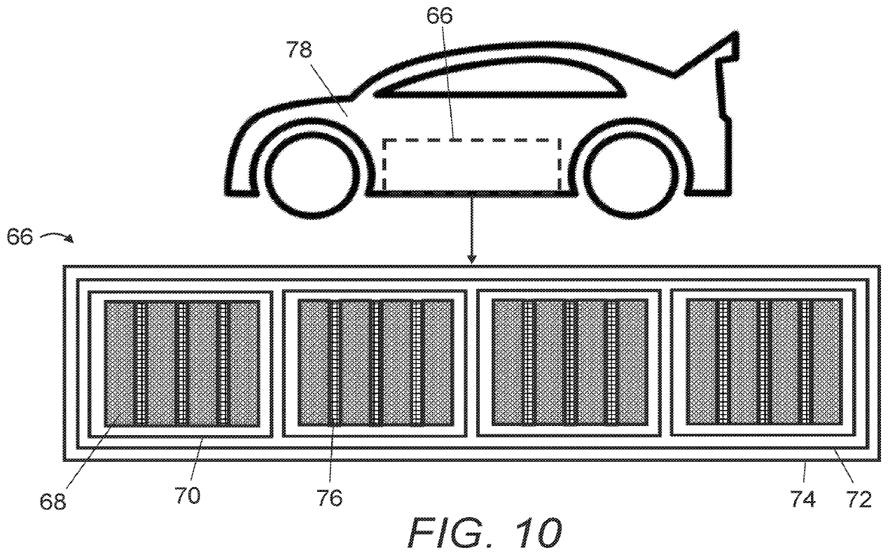

For example, and referring to FIG. 10, shown is a battery 66 including battery cells 68. Cells 68 can be grouped into battery modules 70, and the modules can be assembled into a battery pack 72. Battery 66 can further include a battery enclosure or box 74. In order to isolate cells 68, modules 70, and/or pack 72 from vibration and/or to account for expansion/contraction of the cells, modules, and/or pack, battery 66 can also include one or more compression pads 76, which can be disposed between ones of the cells, between ones of the modules, between the pack and box 74, and/or the like. Compression pads 76 can comprise, for example, a compressible material, such as a foam. Battery 66 can be included in a vehicle 78, such as the shown automobile. Vehicle 78 can otherwise be, for example, a motor vehicle (e.g. an internal combustion engine vehicle, an electric vehicle, a hybrid electric vehicle), an aircraft (e.g., an airplane, jet, helicopter, unmanned aerial vehicle, or electric vertical take-off and landing (eVTOL) aircraft), a train, a motorcycle, a watercraft, a spacecraft, or the like.

Such a battery 66, however, can be susceptible to thermal runaway events and/or exposed to other high-temperature environments. To protect battery 66, vehicle 78 in which the battery is disposed, and/or occupants of the vehicle, one or more of the present laminates can be implemented. To illustrate, one of the present laminates can be disposed on an interior and/or exterior surface of at least one of cells 68, modules 70, pack 72, compression pads 76, and/or box 74.

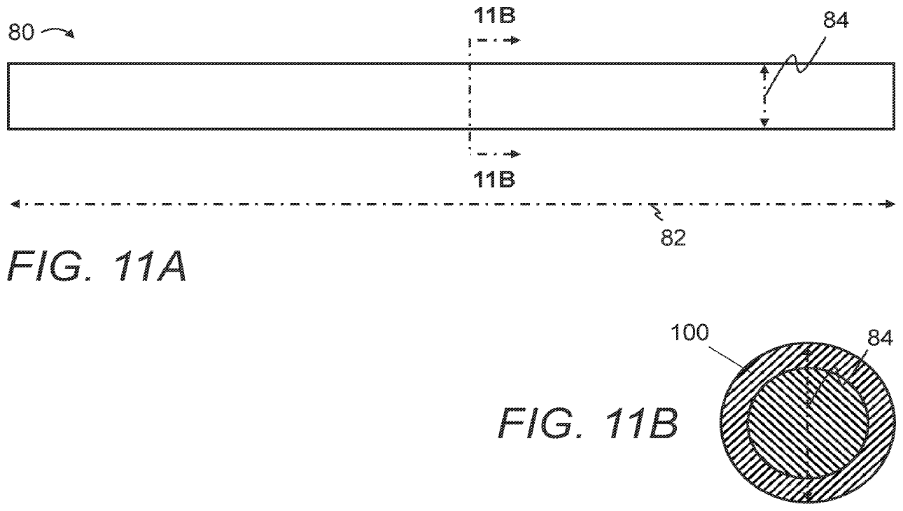

As another example and referring to FIGS. 11A and 11B, shown is a cable 80. Cable 80 can have a length 82 and a width or diameter 84, where the length is longer than the width (e.g., 10 or more times the width). More specifically, diameter 84 can be from 0.0003 inches to 10 inches, preferably 0.001 inches to 1 inch. Cable 80 can, but need not, be electrically conductive. Cable can be comprised in a vehicle (e.g., as described above), a missile, rocket, artillery, manned aircraft, unmanned aircraft, terrestrial vehicle, sea vehicle, or spacecraft. Such a cable can be exposed to high temperatures, and the present laminates can be used to mitigate the same. For example, cable 80 can include one or more of the present laminates (e.g., indicated as 100 in FIG. 7B) that form at least a portion of an exterior surface of the cable.

Non-limiting examples of articles of manufacture that can include a laminate(s) of the present invention include, in addition to the above, vehicles, trucks, trailers, trains, rail vehicles, aircraft, spacecraft, body panels or parts for any of the foregoing, bridges, pipelines, pipes, piping, boats, ships, storage containers, storage tanks, furniture, windows, doors, railings, functional or decorative building pieces, pipe railings, electrical components, conduits, beverage containers, food containers, foils, batteries (e.g., electric vehicle batteries, battery systems, battery casings), and battery busbars.

### B. Materials of Layers of Polymeric Aerogel

A layer of polymeric aerogel can include organic materials, inorganic materials, or a mixture thereof. Organic aerogels can be made from polyacrylates, polystyrenes, polyacrylonitriles, polyurethanes, polyurea, polyimides, polyamides, polyaramids, polyfurfural alcohol, phenol furfuryl alcohol, melamine formaldehydes, resorcinol formaldehydes, cresol formaldehyde, phenol formaldehyde, polyvinyl alcohol dialdehyde, polycyanurates, polyacrylamides, various epoxies, agar, agarose, and the like. In particular embodiments, the aerogel is a polyimide aerogel.

Polyimides are a type of polymer with many desirable properties. Polyimide polymers include a nitrogen atom in the polymer backbone, where the nitrogen atom is connected to two carbonyl carbons, such that the nitrogen atom is somewhat stabilized by the adjacent carbonyl groups. A carbonyl group includes a carbon, referred to as a carbonyl carbon, which is double bonded to an oxygen atom. Polyimides are usually considered an AA-BB type polymer because usually two different classes of monomers are used to produce the polyimide polymer. Polyimides can also be prepared from AB type monomers. For example, an aminodicarboxylic acid monomer can be polymerized to form an AB type polyimide. Monoamines and/or mono anhydrides can be used as end capping agents if desired.

One class of polyimide monomer is usually a diamine, or a diamine monomer. The diamine monomer can also be a diisocyanate, and it is to be understood that an isocyanate could be substituted for an amine in this description, as appropriate. There are other types of monomers that can be used in place of the diamine monomer, as known to those skilled in the art. The other type of monomer is called an acid monomer, and it is usually in the form of a dianhydride. In this description, the term “di-acid monomer” is defined to include a dianhydride, a tetraester, a diester acid, a tetracarboxylic acid, or a trimethylsilyl ester, all of which can react with a diamine to produce a polyimide polymer. Dianhydrides are to be understood as tetraesters, diester acids, tetracarboxylic acids, or trimethylsilyl esters that can be substituted, as appropriate. There are also other types of monomers that can be used in place of the di-acid monomer, as known to those skilled in the art.

Because one di-acid monomer has two anhydride groups, different diamino monomers can react with each anhydride group so the di-acid monomer may become located between two different diamino monomers. The diamine monomer contains two amine functional groups; therefore, after the first amine functional group attaches to one di-acid monomer, the second amine functional group is still available to attach to another di-acid monomer, which then attaches to another diamine monomer, and so on. In this manner, the polymer backbone is formed. The resulting polycondensation reaction forms a polyamic acid.

The polyimide polymer is usually formed from two different types of monomers, and it is possible to mix different varieties of each type of monomer. Therefore, one, two, or more di-acid monomers can be included in the reaction vessel, as well as one, two, or more diamino monomers. The total molar quantity of di-acid monomers is kept about the same as the total molar quantity of diamino monomers if a long polymer chain is desired. Because more than one type of diamine or di-acid can be used, the various monomer constituents of each polymer chain can be varied to produce polyimides with different properties. For example, a single diamine monomer AA can be reacted with two di-acid co monomers, B₁B₁ and B₂B₂, to form a polymer chain of the general form of (AA-B₁B₁)ₓ-(AA-B₂B₂)_{y} in which x and y are determined by the relative incorporations of B₁B₁ and B₂B₂ into the polymer backbone. Alternatively, diamine co-monomers A₁A₁ and A₂A₂ can be reacted with a single di-acid monomer BB to form a polymer chain of the general form of (A₁A₁-BB)ₓ-(A₂A₂-BB)_{y}. Additionally, two diamine co-monomers A₁A₁ and A₂A₂ can be reacted with two di-acid co-monomers B₁B₁ and B₂B₂ to form a polymer chain of the general form (A₁A₁-B₁B₁)_{w}-(A₁A₁-B₂B₂)ₓ-(A₂A₂-B₁B₁)_{y}-(A₂A₂-B₂B₂)_{z}, where w, x, y, and z are determined by the relative incorporation of A₁A₁-B₁B₁, A₁A₁-B₂B₂, A₂A₂-B₁B₁, and A₂A₂-B₂B₂ into the polymer backbone. More than two di-acid co-monomers and/or more than two diamine co-monomers can also be used. Therefore, one or more diamine monomers can be polymerized with one or more di-acids, and the general form of the polymer is determined by varying the amount and types of monomers used.

There are many examples of monomers that can be used to make polymeric aerogels containing polyamic amide polymer. In some embodiments, the diamine monomer is a substituted or unsubstituted aromatic diamine, a substituted or unsubstituted alkyldiamine, or a diamine that can include both aromatic and alkyl functional groups. A non-limiting list of possible diamine monomers comprises 4,4′-oxydianiline (ODA), 3,4′-oxydianiline, 3,3′-oxydianiline, p-phenylenediamine, m-phenylenediamine, o-phenylenediamine, diaminobenzanilide, 3,5-diaminobenzoic acid, 3,3′-diaminodiphenylsulfone, 4,4′-sulfones, 1,3-bis-(4-aminophenoxy)benzene, 1,3-bis-(3-diaminodiphenyl aminophenoxy)benzene, 1,4-bis-(4-aminophenoxy)benzene, 1,4-bis-(3-aminophenoxy)benzene, 2,2-bis[4-(4-aminophenoxy)phenyl]-hexafluoropropane, 2,2-bis(3-4,4′-isopropylidenedianiline, 1-(4-aminophenyl)-1,1,1,3,3,3-hexafluoropropane, aminophenoxy)-3-(3-aminophenoxy)benzene, 1-(4-aminophenoxy)-4-(3-aminophenoxy)benzene, bis-[4-(4-aminophenoxy)phenyl]sulfones, 2,2-bis[4-(3-aminophenoxy)phenyl]sulfones, bis(4-[4-aminophenoxy]phenyl) ether, 2,2′-bis-(4-aminophenyl)-hexafluoropropane (6F-diamine), 2,2′-bis-(4-phenoxyaniline) isopropylidene, meta-phenylenediamine, para-phenylenediamine, 1,2-diaminobenzene, 4,4′-diaminodiphenylmethane, 2,2-bis(4-aminophenyl)propane, 4,4′diaminodiphenyl propane, 4,4′-diaminodiphenyl sulfide, 4,4′-diaminodiphenylsulfone, 3,4′diaminodiphenyl ether, 4,4′-diaminodiphenyl ether, 2,6-diaminopyridine, bis(3-aminophenyl)diethyl silane, 4,4′-diaminodiphenyl diethyl silane, benzidine, dichlorobenzidine, 3,3′-dimethoxybenzidine, 4,4′-diaminobenzophenone, N,N-bis(4-aminophenyl)-n-butylamine, N,N-bis(4-aminophenyl)methylamine, 1,5-diaminonaphthalene, 3,3′-dimethyl-4,4′-diaminobiphenyl, 4-aminophenyl-3-aminobenzoate, N,N-bis(4-aminophenyl)aniline, bis(p-beta-amino-t-butylphenyl) ether, p-bis-2-(2-methyl-4-aminopentyl)benzene, p-bis(1,1-dimethyl-5-aminopentyl)benzene, 1,3-bis(4-aminophenoxy)benzene, m-xylenediamine, p-xylenediamine, 4,4′-diaminodiphenyl ether phosphine oxide, 4,4′-diaminodiphenyl N-methyl amine, 4,4′-diaminodiphenyl N-phenyl amine, amino-terminal polydimethylsiloxanes, amino-terminal polypropyleneoxides, amino-terminal polybutyleneoxides, 4,4′-Methylenebis(2-methylcyclohexylamine), 1,2-diaminoethane, 1,3-diaminopropane, 1,4-diaminobutane, 1,5-diaminopentane, 1,6-diaminohexane, 1,7-diaminoheptane, 1,8-diaminooctane, 1,9-diaminononane, 1,10-diaminodecane, and 4,4′-methylenebisbenzeneamine, 2,2′-dimethylbenzidine, (also known as 4,4′-diamino-2,2′-dimethylbiphenyl (DMB)), bisaniline-p-xylidene, 4,4′-bis(4-aminophenoxy) biphenyl, 3,3′-bis (4 aminophenoxy) biphenyl, 4,4′-(1,4-phenylenediisopropylidene)bisaniline, and 4,4′-(1,3-phenylenediisopropylidene)bisaniline, or combinations thereof. In a specified embodiment, the diamine monomer is ODA, 2,2′-dimethylbenzidine, or both.

A non-limiting list of possible dianhydride (“diacid”) monomers includes hydroquinone dianhydride, 3,3′,4,4′-biphenyltetracarboxylic dianhydride (BPDA), pyromellitic dianhydride (PMDA), 3,3′,4,4′-benzophenonetetracarboxylic dianhydride, 4,4′-oxydiphthalic anhydride, 3,3′,4,4′-diphenylsulfonetetracarboxylic dianhydride, 4,4′-(4,4′-isopropylidenediphenoxy)bis(phthalic anhydride), 2,2-bis(3,4-dicarboxyphenyl)propane dianhydride, 4,4′-(hexafluoroisopropylidene)diphthalic anhydride, bis(3,4-dicarboxyphenyl) sulfoxide dianhydride, polysiloxane-containing dianhydride, 2,2′,3,3′-biphenyltetracarboxylic dianhydride, 2,3,2′,3′-benzophenonetetraearboxylic dianhydride, naphthalene-2,3,6,7-tetracarboxylic dianhydride, naphthalene-1,4,5,8-tetracarboxylic dianhydride, 4,4′-oxydiphthalic dianhydride, 3,3′,4,4′-biphenylsulfone tetracarboxylic dianhydride, 3,4,9,10-perylene tetracarboxylic dianhydride, bis(3,4-dicarboxyphenyl) sulfide dianhydride, bis(3,4-dicarboxyphenyl) methane dianhydride, 2,2-bis(3,4-dicarboxyphenyl)propane dianhydride, 2,2-bis(3,4-dicarboxyphenyl)hexafluoropropane, 2,6-dichloronaphthalene-1,4,5,8-tetracarboxylic dianhydride, 2,7-dichloronapthalene-1,4,5,8-tetracarboxylic dianhydride, 2,3,6,7-tetrachloronaphthalene-1,4,5,8-tetracarboxylic dianhydride, phenanthrene, 8,9,10-tetracarboxylic dianhydride, pyrazine-2,3,5,6-tetracarboxylic dianhydride, benzene-1,2,3,4-tetracarboxylic dianhydride, and thiophene-2,3,4,5-tetracarboxylic dianhydride. In a specific embodiment, the dianhydride monomer is BPDA, PMDA, or both.

In some aspects, the molar ratio of anhydride to total diamine is from 0.4:1 to 1.6:1, 0.5:1 to 1.5:1, 0.6:1 to 1.4:1, 0.7:1 to 1.3:1, or specifically from 0.8:1 to 1.2:1. In further aspects, the molar ratio of dianhydride to multifunctional amine (e.g., triamine) is 2:1 to 140:1, 3:1 to 130:1, 4:1 to 120:1, 5:1 to 110:1, 6:1 to 100:1, 7:1 to 90:1, or specifically from 8:1 to 80:1. Mono-anhydride groups can also be used. Non-limiting examples of mono-anhydride groups include 4-amino-1,8-naphthalic anhydride, endo-bicyclo[2.2.2]oct-5-ene-2,3-dicarboxylic anhydride, citraconic anhydride, trans-1,2-cyclohexanedicarboxylic anhydride, 3,6-dichlorophthalic anhydride, 4,5-dichlorophthalic anhydride, tetrachlorophthalic anhydride 3,6-difluorophthalic anhydride, 4,5-difluorophthalic anhydride, tetrafluorophthalic anhydride, maleic anhydride, 1-cyclopentene-1,2-dicarboxylic anhydride, 2,2-dimethylglutaric anhydride 3,3-dimethylglutaric anhydride, 2,3-dimethylmaleic anhydride, 2,2-dimethylsuccinic anhydride, 2,3-diphenylmaleic anhydride, phthalic anhydride, 3-methylglutaric anhydride, methylsuccinic anhydride, 3-nitrophthalic anhydride, 4-nitrophthalic anhydride, 2,3-pyrazinedicarboxylic anhydride, or 3,4-pyridinedicarboxylic anhydride. Specifically, the mono-anhydride group can be phthalic anhydride.

In another embodiment, the polymer compositions used to prepare layers of polymeric aerogel include multifunctional amine monomers with at least three primary amine functionalities. The multifunctional amine may be a substituted or unsubstituted aliphatic multifunctional amine, a substituted or unsubstituted aromatic multifunctional amine, or a multifunctional amine that includes a combination of an aliphatic and two aromatic groups, or a combination of an aromatic and two aliphatic groups. A non-limiting list of possible multifunctional amines include propane-1,2,3-triamine, 2-aminomethylpropane-1,3-diamine, 3-(2-aminoethyl)pentane-1,5-diamine, bis(hexamethylene)triamine, N′,N′-bis(2-aminoethyl)ethane-1,2-diamine, N′,N′-bis(3-aminopropyl)propane-1,3-diamine, 4-(3-aminopropyl)heptane-1,7-diamine, N′,N′-bis(6-aminohexyl)hexane-1,6-diamine, benzene-1,3,5-triamine, cyclohexane-1,3,5-triamine, melamine, N-2-dimethyl-1,2,3-propanetriamine, diethylenetriamine, 1-methyl or 1-ethyl or 1-propyl or 1-benzyl-substituted diethylenetriamine, 1,2-dibenzyldiethylenetriamine, lauryldiethylenetriamine, N-(2-hydroxypropyl)diethylenetriamine, N,N-bis(1-methylheptyl)-N-2-dimethyl-1,2,3-propanetriamine, 2,4,6-tris(4-(4-aminophenoxy)phenyl)pyridine, N,N-dibutyl-N-2-dimethyl-1,2,3-propanetriamine, 4,4′-(2-(4-aminobenzyl)propane-1,3-diyl)dianiline, 4-((bis(4-aminobenzyl)amino)methyl)aniline, 4-(2-(bis(4-aminophenethyl)amino)ethyl)aniline, 4,4′-(3-(4-aminophenethyl)pentane-1,5-diyl)dianiline, 1,3,5-tris(4-aminophenoxy)benzene (TAPOB), 4,4′,4″-methanetriyltrianiline, N,N,N′,N′-Tetrakis(4-aminophenyl)-1,4-phenylenediamine, a polyoxypropylenetriamine, octa(aminophenyl)polyhedral oligomeric silsesquioxane, or combinations thereof. A specific example of a polyoxypropylenetriamine is JEFFAMINE® T-403 from Huntsman Corporation, The Woodlands, TX USA. In a specific embodiment, the aromatic multifunctional amine may be 1,3,5-tris(4-aminophenoxy)benzene or 4,4′,4″-methanetriyltrianiline. In some embodiments, the multifunctional amine includes three primary amine groups and one or more secondary and/or tertiary amine groups, for example, N′,N′-bis(4-aminophenyl)benzene-1,4-diamine.

Non-limiting examples of capping agents or groups include amines, maleimides, nadimides, acetylene, biphenylenes, norbornenes, cycloalkyls, and N-propargyl, and specifically those derived from reagents including 5-norbornene-2,3-dicarboxylic anhydride (nadic anhydride, NA), methyl-nadic anhydride, hexachloro-nadic anhydride, cis-4-cyclohexene-1,2-dicarboxylic anhydride, 4-amino-N-propargylphthalimide, 4-ethynylphthalic anhydride, and maleic anhydride.

The characteristics or properties of the final polymer are significantly impacted by the choice of monomers that are used to produce the polymer. Factors to be considered when selecting monomers include the properties of the final polymer, such as the flexibility, thermal stability, coefficient of thermal expansion (CTE), coefficient of hydroscopic expansion (CHE), and any other properties specifically desired, as well as cost. Often, certain important properties of a polymer for a particular use can be identified. Other properties of the polymer may be less significant, or may have a wide range of acceptable values; so many different monomer combinations could be used.

In some instances, the backbone of the polymer can include substituents. The substituents (e.g., oligomers, functional groups, etc.) can be directly bonded to the backbone or linked to the backbone through a linking group (e.g., a tether or a flexible tether). In other embodiments, a compound or particles can be incorporated (e.g., blended and/or encapsulated) into the polyimide structure without being covalently bound to the polyimide structure. In some instances, the incorporation of the compound or particles can be performed during the polyamic reaction process. In some instances, particles can aggregate, thereby producing polyimides having domains with different concentrations of the non-covalently bound compounds or particles.

Specific properties of a polyimide can be influenced by incorporating certain compounds into the polyimide. The selection of monomers is one way to influence specific properties. Another way to influence properties is to add a compound or property modifying moiety to the polyimide.

### C. Preparation of Layers of Polymeric Aerogel

Polymeric aerogel films that can be used in at least some of the present laminates are commercially-available. Non-limiting examples of such films include the Blueshift AeroZero® rolled thin film (available from Blueshift Materials, Inc. (Spencer, Massachusetts)) and Airloy® films (available from Aerogel Technologies, LLC), with the Blueshift AeroZero® rolled thin film being preferred in some aspects.

Further, and in addition to the processes discussed below, polymeric aerogels (films, stock shapes or monoliths, etc.) can be made using the methodology described in Patent Application Publication Nos. WO 2014/189560 to Rodman et al., US 2017/0355829 to Sakaguchi et al., US 2018/078512 to Yang et al., US 2018/140804 to Sakaguchi et al., and US 2019/006184 to Irvin et al., International Patent Application No. PCT/US2019/029191 to Ejaz et al., U.S. Patent Application Publication No. 2017/0121483 to Poe et al., and/or U.S. Pat. No. 9,963,571 to Sakaguchi et al., all of which are incorporated herein by reference in their entireties.

The following provides non-limiting processes that can be used to make layers of polymeric aerogel suitable for use in the present laminates. These processes can include: (1) preparation of the polymer gel; (2) optional solvent exchange, (3) drying of the polymeric solution to form the aerogel; and (4) attaching a polymeric aerogel film on a substrate.

### 1. Formation of a Polymer Gel

The first stage in the synthesis of an aerogel can be the synthesis of a polymerized gel. For example, if a polyimide aerogel is desired, at least one acid monomer can be reacted with at least one diamino monomer in a reaction solvent to form a polyamic acid. As discussed above, numerous acid monomers and diamino monomers may be used to synthesize the polyamic acid. In one aspect, the polyamic acid is contacted with an imidization catalyst in the presence of a chemical dehydrating agent to form a polymerized polyimide gel via an imidization reaction. “Imidization” is defined as the conversion of a polyimide precursor into an imide. Any imidization catalyst suitable for driving the conversion of polyimide precursor to the polyimide state is suitable. Non-limiting examples of chemical imidization catalysts include pyridine, methylpyridines, quinoline, isoquinoline, 1,8-diazabicyclo[5.4.0]undec-7-ene (DBU), triethylenediamine, lutidine, N-methylmorpholine, triethylamine, tripropylamine, tributylamine, other trialkylamines, 2-methyl imidazole, 2-ethyl-4-methylimidazole, imidazole, other imidazoles, and combinations thereof. Any dehydrating agent suitable for use in formation of an imide ring from an amic acid precursor is suitable for use in the methods of the present invention. Preferred dehydrating agents comprise at least one compound selected from the group consisting of acetic anhydride, propionic anhydride, n-butyric anhydride, benzoic, anhydride, trifluoroacetic anhydride, phosphorus trichloride, and dicyclohexylcarbodiimide.

In one aspect of the current invention, one or more diamino monomers and one or

more multifunctional amine monomers are premixed in one or more solvents and then treated with one or more dianhydrides (e.g., di-acid monomers) that are added in sequentially smaller amounts at pre-defined time increments while monitoring the viscosity. The desired viscosity of the polymerized solution can range from 50 to 20,000 cP or specifically 500 to 5,000 cP.

By performing the reaction using incremental addition of dianhydride while monitoring viscosity, a non-crosslinked aerogel can be prepared. For instance, a triamine monomer (23 equiv.) can be added to the solvent to give a 0.0081 molar solution. To the solution, a first diamine monomer (280 equiv.) can be added, followed by a second diamine monomer (280 equiv.). Next a dianhydride (552 total equiv.) can be added in sequentially smaller amounts at pre-defined time increments while monitoring the viscosity. The dianhydride can be added until the viscosity reaches 1,000 to 1,500 cP. For example, a first portion of dianhydride can be added, the reaction can be stirred (e.g., for 20 minutes), a second portion of dianhydride can be added, and a sample of the reaction mixture can then be analyzed for viscosity. After stirring for additional time (e.g., for 20 minutes), a third portion of dianhydride can be added, and a sample can be taken for analysis of viscosity. After further stirring for a desired period of time (e.g., 10 hours to 12 hours), a mono-anhydride (96 equiv.) can be added. After having reached the target viscosity, the reaction mixture can be stirred for a desired period of time (e.g., 10 hours to 12 hours) or the reaction is deemed completed.

The reaction temperature for the gel formation can be determined by routine experimentation depending on the starting materials. In a preferred embodiment, the temperature can be greater than or equal to any one of, or between any two of: 15° C., 20° C., 30° C., 35° C., 40° C., and 45° C. After a desired amount of time (e.g., about 2 hours), the product can be isolated (e.g., filtered), after which a nitrogen-containing hydrocarbon (828 equiv.) and dehydration agent (1214 equiv.) can be added. The addition of the nitrogen-containing hydrocarbon and/or dehydration agent can occur at any temperature. In some embodiments, the nitrogen-containing hydrocarbon and/or dehydration agent is added to the solution at 20° C. to 28° C. (e.g., room temperature) and stirred for a desired amount of time at that temperature. In some instances, after addition of nitrogen-containing hydrocarbon and/or dehydration agent, the solution temperature is raised up to 150° C.

The reaction solvent can include dimethylsulfoxide (DMSO), diethylsulfoxide, N,N-dimethylformamide (DMF), N,N-diethylformamide, N,N-dimethylacetamide (DMAc), N,N-diethylacetamide, N-methyl-2-pyrrolidone (NMP), 1-methyl-2-pyrrolidinone, N-cyclohexyl-2-pyrrolidone, 1,13-dimethyl-2-imidazolidinone, diethyleneglycoldimethoxyether, o-dichlorobenzene, phenols, xylenol, cresols, catechol, butyrolactones, hexamethylphosphoramide, and mixtures thereof. The reaction solvent and other reactants can be selected based on the compatibility with the materials and methods applied; i.e., if the polymerized polyamic amide gel is to be cast onto a support film, injected into a moldable part, or poured into a shape for further processing into a workpiece. In a specific embodiment, the reaction solvent is DMSO.

In one non-limiting manner, the formation of macropores versus smaller mesopores and micropores can be primarily controlled by controlling the polymer/solvent dynamics during gel formation. By doing so, the pore structure can be controlled, and the quantity and volume of macroporous, mesoporous, and microporous cells can be controlled. For example, a curing additive that reduces the solubility of the polymers being formed during polymerization, such as 1,4-diazabicyclo[2.2.2]octane, can produce a polymer gel containing a higher number of macropores as compared to another curing additive that improves the resultant polymer solubility, such as triethylamine. In another specific non-limiting example, when forming a polyimide aerogel, increasing the ratio of rigid amines (e.g., p-phenylenediamine (p-PDA)) to more flexible diamines (e.g., -ODA) incorporated into the polymer backbone can favor the formation of macropores over smaller mesopores and micropores.

The polymer solution may optionally be cast onto a casting sheet covered by a support film for a period of time. Casting can include spin casting, gravure coating, three roll coating, knife over roll coating, slot die extrusion, dip coating, Meyer rod coating, or other techniques. In one embodiment, the casting sheet is a polyethylene terephthalate (PET) casting sheet. After a passage of time, the polymerized reinforced gel is removed from the casting sheet and prepared for the solvent exchange process. In some embodiments, the cast film can be heated in stages to elevated temperatures to remove solvent and convert the amic acid functional groups in the polyamic acid to imides with a cyclodehydration reaction, also called imidization. In some instances, polyamic acids may be converted in solution to polyimides with the addition of the chemical dehydrating agent, catalyst, and/or heat.

In some embodiments, the polyimide polymers can be produced by preparing a polyamic acid polymer in the reaction vessel. The polyamic acid is then formed into a sheet or a film and subsequently processed with catalysts or heat and catalysts to convert the polyamic acid to a polyimide.

Wet gels used to prepare aerogels may be prepared by any known gel-forming techniques, for example adjusting the pH and/or temperature of a dilute metal oxide sol to a point where gelation occurs.

### 2. Optional Solvent Exchange

After the polymer gel is synthesized, it may be desirable in certain instances to conduct a solvent exchange wherein the reaction solvent is exchanged for a more desirable second solvent. Accordingly, in one embodiment, a solvent exchange can be conducted wherein the polymerized gel is placed inside of a pressure vessel and submerged in a mixture comprising the reaction solvent and the second solvent. Then, a high-pressure atmosphere is created inside of the pressure vessel, thereby forcing the second solvent into the polymerized gel and displacing a portion of the reaction solvent. Alternatively, the solvent exchange step may be conducted without the use of a high-pressure environment. It may be necessary to conduct a plurality of rounds of solvent exchange. In some embodiments, solvent exchange is not necessary.

The time necessary to conduct the solvent exchange will vary depending upon the type of polymer undergoing the exchange as well as the reaction solvent and second solvent being used. In one embodiment, each solvent exchange can take from 1 to 168 hours or any period time there between, including 2, 3, 4, 5, 6, 7, 8, 9, 10, 11, 12, 13, 14, 15, 16, 17, 18, 19, 20, 21, 22, or 23, 24, 25, 50, 75, 100, 125, 150, 155, 160, 165, 166, 167, or 168 hours. In another embodiment, each solvent exchange can take approximately 1 to 60 minutes, or about 30 minutes. Exemplary second solvents include methanol, ethanol, 1-propanol, 2-propanol, 1-butanol, 2-butanol, isobutanol, tert-butanol, 3-methyl-2-butanol, 3,3-dimethyl-2-butanol, 2-pentanol, 3-pentanol, 2,2-dimethylpropan-1-ol, cyclohexanol, diethylene glycol, cyclohexanone, acetone, acetyl acetone, 1,4-dioxane, diethyl ether, dichloromethane, trichloroethylene, chloroform, carbon tetrachloride, water, and mixtures thereof. In certain non-limiting embodiments, the second solvent can have a suitable freezing point for performing supercritical or subcritical drying steps. For example, tert-butyl alcohol has a freezing point of 25.5° C. and water has a freezing point of 0° C. under one atmosphere of pressure. Alternatively, and as discussed below, however, the drying can be performed without the use of supercritical or subcritical drying steps, such as by evaporative drying techniques.

The temperature and pressure used in the solvent exchange process may be varied. The duration of the solvent exchange process can be adjusted by performing the solvent exchange at a varying temperatures or atmospheric pressures, or both, provided that the pressure and temperature inside the pressure vessel do not cause either the first solvent or the second solvent to leave the liquid phase and become gaseous phase, vapor phase, solid phase, or supercritical fluid. Generally, higher pressures and/or temperatures decrease the amount of time required to perform the solvent exchange, and lower temperatures and/or pressures increase the amount of time required to perform the solvent exchange.

### 3. Cooling and Drying

In one embodiment, after solvent exchange, the polymerized gel can be exposed to supercritical drying. In this instance, the solvent in the gel can be removed by supercritical CO₂ extraction.

In another embodiment, after solvent exchange, the polymerized gel can be exposed to subcritical drying. In this instance, the gel can be cooled below the freezing point of the second solvent and subjected to a freeze drying or lyophilization process to produce the aerogel. For example, if the second solvent is water, then the polymerized gel is cooled to below 0° C. After cooling, the polymerized gel can be subjected to a vacuum for a period of time to allow sublimation of the second solvent.

In still another embodiment, after solvent exchange, the polymerized gel can be exposed to subcritical drying with optional heating after the majority of the second solvent has been removed through sublimation. In this instance the partially dried gel material is heated to a temperature near or above the boiling point of the second solvent for a period of time. The period of time can range from a few hours to several days, although a typical period of time is approximately 4 hours. During the sublimation process, a portion of the second solvent present in the polymerized gel is removed, leaving a gel that can have macropores, mesopores, or micropores, or any combination thereof or all of such pore sizes. After the sublimation process is complete, or nearly complete, the aerogel has been formed.

In yet another embodiment, after solvent exchange, the polymerized gel can be dried under ambient conditions, for example, by removing the solvent under a stream of gas (e.g., air, anhydrous gas, inert gas (e.g., nitrogen (N₂) gas), etc.). Still further, passive drying techniques can be used such as simply exposing the gel to ambient conditions without the use of a gaseous stream.

Once cooled or dried, the films and stock shapes can be configured for use in the present laminates. For example, the films or stock shapes can be processed into desired shapes (e.g., by cutting or grinding) such as square shapes, rectangular shapes, circular shapes, triangular shapes, irregular shapes, random shapes, etc. Also, and as discussed above, the films or stock shapes can be affixed to a support material such as with an adhesive. In alternative embodiments, a support material can be incorporated into the matrix of the polymeric aerogel, which is discussed below.

4. Incorporation of a Reinforcing Layer into the Matrix of the Polymeric Aerogel

In addition to the methods discussed above with respect to the use of adhesives for attaching a polymeric aerogel to a support material, an optional embodiment of the present invention can include incorporation of the support material into the polymeric matrix to create a reinforced polymeric aerogel without the use of adhesives. Notably, during manufacture of a non-reinforced polymer aerogel, a reinforcing support film can be used as a carrier to support the gelled film during processing. During rewinding, the gelled film can be irreversibly pressed into the carrier film. Pressing the gelled film into the carrier film can provide substantial durability improvement. In another instance, during the above-mentioned solvent casting step, the polymer solution can be cast into a reinforcement or support material.

The substrate selection and direct casting can allow optimization of (e.g., minimization) of the thickness of the resulting reinforced aerogel material. This process can also be extended to the production of fiber-reinforced polymer aerogels-internally reinforced polyimide aerogels are provided as an example. The process can include: (a) forming a polyamic acid solution from a mixture of dianhydride and diamine monomers in a polar solvent such as DMSO, DMAc, NMP, or DMF; (b) contacting the polyamic acid solution with chemical curing agents listed above and a chemical dehydrating agent to initiate chemical imidization; (c) casting the polyamic acid solution onto a fibrous support prior to gelation and allow it to permeate it; (d) allowing the catalyzed polyamic acid solution to gel around, and into, the fibrous support during chemical imidization; (e) optionally performing a solvent exchange, which can facilitate drying; and (f) removal of the transient liquid phase contained within the gel with supercritical, subcritical, or ambient drying to give an internally reinforced aerogel.

### D. Non-Limiting Aspects of the Present Invention

The present invention can include the following non-limiting aspects.
Aspect 1: A laminate comprising: a flame-retardant layer having a flammability rating compliant with at least one plastic flammability standard; and an aerogel layer; wherein: the laminate has opposing front and back surfaces; the flame-retardant layer defines at least a majority of the front surface; and a thickness of the laminate is less than or equal to 25.4 millimeters (mm).
Aspect 2: The laminate of aspect 1, wherein the thickness of the laminate is less than or equal to 10 mm, preferably less than or equal to 5 mm, more preferably less than or equal to 2 mm, or even more preferably from 0.3 mm to 2 mm.
Aspect 3: The laminate of any one of aspects 1 or 2, wherein a thickness of the flame-retardant layer is from 0.05 mm to 0.8 mm.
Aspect 4: The laminate of any one of aspects 1-3, wherein the flame-retardant layer is not electrically-insulative.
Aspect 5: The laminate of any one of aspects 1-3, wherein the flame-retardant layer is electrically insulative.
Aspect 6: The laminate of any one of aspects 1-5, wherein the plastic flammability standard is UL94 5VA or UL94 5VB, and wherein the flammability rating of the flame-retardant layer is compliant with UL94 5VA or UL94 5VB.
Aspect 7: The laminate of any one of aspects 1-6, wherein the flammability rating of the laminate is compliant with a plastic flammability standard, preferably UL94 5VB, more preferably UL94 5VA.
Aspect 8: The laminate of any one of aspects 1-7, wherein the flame-retardant layer comprises fibers.
Aspect 9: The laminate of aspect 8, wherein the fibers are non-woven.
Aspect 10: The laminate of aspect 8, wherein the fibers are woven.
Aspect 11: The laminate of any one of aspects 1-10, wherein the flame-retardant layer comprises one or more of metal hydroxides, organophosphates, alumina hydroxide, inorganic fillers, and/or metal oxides.
Aspect 12: The laminate of any one of aspects 1-11, wherein the flame-retardant layer comprises a silicate.
Aspect 13: The laminate of aspect 12, wherein the silicate comprises a mica, and wherein the flame-retardant layer preferably comprises at least 90% by weight of the mica.
Aspect 14: The laminate of any one of aspects 1-13, wherein the flame-retardant layer comprises a ceramic, and wherein the flame-retardant layer preferably comprises at least 90% by weight of the ceramic.
Aspect 15: The laminate of aspect 14, wherein the ceramic comprises a metal oxide or a non-metal oxide or a combination thereof.
Aspect 16: The laminate of aspect 15, wherein the ceramic comprises alumina, beryllia, ceria, zirconia, carbide, boride, nitride, or silicide, or any combination thereof.
Aspect 17: The laminate of any one of aspects 1-16, wherein the flame-retardant layer is halogen-free.
Aspect 18: The laminate of any one of aspects 1-17, wherein a thickness of the aerogel layer is between 0.05 mm and 0.254 mm.
Aspect 19: The laminate of any one of aspects 1-18, wherein the aerogel layer is a polymeric aerogel layer.
Aspect 20: The laminate of any one of aspects 1-19, wherein the polymeric aerogel layer comprises at least 50% by weight of polyimide.
Aspect 21: The laminate of any one of aspects 1-20, wherein the aerogel layer has a decomposition temperature that is greater than or equal to 400° C., preferably from 400° C. to 600° C.
Aspect 22: The laminate of any of aspects 1-21, comprising one or more adhesive layers coupled to the aerogel layer.
Aspect 23: The laminate of aspect 22, wherein a first one of the adhesive layer(s) is disposed between the flame-retardant layer and the aerogel layer.
Aspect 24: The laminate of aspect 23, wherein the first adhesive layer has a melting temperature or a decomposition temperature that is greater than 500° C.
Aspect 25: The laminate of aspect 23 or 24, wherein at least a portion of the back surface is defined by: a second one of the adhesive layer(s); or a liner layer removably disposed on the second adhesive layer.
Aspect 26: The laminate of any of aspects 22-25, wherein each of the adhesive layer(s) comprises a pressure-sensitive adhesive.
Aspect 27: The laminate of any of aspects 22-26, wherein each of the adhesive layer(s) comprises a silicone adhesive compound and/or an epoxy compound.
Aspect 28: The laminate of any of aspects 1-27, wherein any one of, any combination of, or all of the flame-retardant layer, the aerogel layer, and the adhesive layer are perforated.
Aspect 29: The laminate of any one of aspects 1-28, wherein the laminate, when attached to a substrate, is capable of maintaining the temperature of the substrate at 500° C. or less when the front surface of the laminate is exposed to a temperature greater than 500° C., preferably 500° C. to 1,500° C., or more preferably 700° C. to 1,200° C., for 1 minute to 90 minutes, preferably for at least 5 minutes.
Aspect 30: The laminate of any one of aspects 1-29, wherein the laminate is disposed in a roll such that a portion of the front surface of the laminate faces a portion of the back surface of the laminate.
Aspect 31: The laminate of any one of aspects 1-30, further comprising a heat-dispersing layer.
Aspect 32: The laminate of aspect 31, wherein the heat-dispersing layer comprises a metal having a thermal conductivity of at least 15 W/m·K, preferably 15 W/m·K to 2,500 W/m·K.
Aspect 33: The laminate of aspect 32, wherein the metal comprises copper, aluminum, molybdenum, tungsten, rhenium, tantalum, niobium, stainless steel, nickel, or an alloy thereof.
Aspect 34: The laminate of aspect 32 or 33, wherein the heat-dispersing layer comprises at least 90%, by weight, of the metal.
Aspect 35: The laminate of aspect 31, wherein the heat-dispersing layer comprises graphite.
Aspect 36: The laminate of aspect 35, wherein the heat-dispersing layer comprises at least 90%, by weight, of the graphite.
Aspect 37: The laminate of any one of aspects 31 to 36, wherein a thickness of the heat-dispersing layer is from 0.001 mm to 0.4 mm, preferably from 0.01 mm to 0.05 mm.
Aspect 38: The laminate of any one of aspects 31 to 37, wherein the heat-dispersing layer is disposed between the flame-retardant layer and the aerogel layer.
Aspect 39: The laminate of aspect 38, comprising a first adhesive layer disposed between the flame-retardant layer and the heat-dispersing layer, and a second adhesive layer disposed between the heat-dispersing layer and the aerogel layer.
Aspect 40: The laminate of aspect 39, wherein the first adhesive layer is in direct contact with the flame-retardant layer and with the heat-dispersing layer, and the second adhesive layer is in direct contact with the heat-dispersing layer and with the aerogel layer.
Aspect 41: The laminate of aspect 39 or 40, further comprising a third adhesive layer and a liner layer, wherein the third adhesive layer is disposed between the aerogel layer and the liner layer.
Aspect 42: The laminate of aspect 41, wherein the third adhesive layer is in direct contact with the aerogel layer and the liner layer.
Aspect 43: The laminate of any one of aspects 39 to 42, wherein the first, second, and/or third adhesive layer: has a melting temperature or a decomposition temperature that is greater than 500° C.; comprises a pressure-sensitive adhesive; and/or comprises a silicone adhesive compound and/or an epoxy compound.
Aspect 44: The laminate of any of aspects 31 to 43, wherein any one of, any combination of, or all of the flame-retardant layer, the heat-dispersing layer, the aerogel layer, and the first, second, and third adhesive layers are perforated.
Aspect 45: The laminate of any one of aspects 1 to 44, further comprising a reinforcing layer.
Aspect 46: The laminate of aspect 45, wherein the reinforcing layer is attached to at least a portion of the flame-retardant layer.
Aspect 47: The laminate of aspect 45 or 46, wherein the reinforcing layer is comprised in at least a portion of a volume of the flame-retardant layer.
Aspect 48: The laminate of any one of aspects 45 to 47, wherein the reinforcing layer comprises fibers.
Aspect 49: The laminate of aspect 48, wherein the fibers comprise glass fibers, carbon fibers, aramid fibers, thermoplastic fibers, thermoset fibers, ceramic fibers, basalt fibers, rock wool fibers, steel fibers, cellulosic fibers, or any combination thereof.
Aspect 50: The laminate of aspect 48 or 49, wherein the fibers are non-woven fibers or are woven fibers.
Aspect 51: An apparatus comprising one or more laminates of any one of aspects 1-50, wherein a first one of the laminate(s) is coupled to the apparatus such that the front surface of the first laminate is disposed further from the apparatus than is the rear surface of the first laminate.
Aspect 52: The apparatus of aspect 51, wherein the apparatus is a battery.
Aspect 53: The apparatus of aspect 52, wherein the battery is comprised in a vehicle, the vehicle comprising: one or more wheels; and one or more electric motors, each configured to rotate at least one of the wheels; wherein the battery is in electrical communication with at least one of the electric motor(s).
Aspect 54: The apparatus of aspect 52 or 53, further comprising: a busbar in electrical communication with the battery; wherein the one or more laminates comprise two or more laminates, a second one of the laminate(s) coupled to the busbar such that the front surface of the second laminate is disposed further from the busbar than is the rear surface of the second laminate.
Aspect 55: The apparatus of any one of aspects 52 to 54, wherein the battery is a lithium-ion battery.
Aspect 56: The apparatus of aspect 51, wherein the apparatus is a busbar.
Aspect 57: The apparatus of aspect 51, wherein the apparatus is a compression pad, a battery cell, a battery module, a battery pack, or a battery box.
Aspect 58: The apparatus of aspect 57, wherein the apparatus is a compression pad, and wherein the compression pad comprises compressible material.
Aspect 59: The apparatus of aspect 58, wherein the compressible material comprises foam.
Aspect 60: The apparatus of aspect 58 or 59, wherein the compression pad is positioned between a first battery cell and a second battery cell.
Aspect 61: The apparatus of aspect 57, wherein the apparatus is a battery cell.
Aspect 62: The apparatus of aspect 57, wherein the apparatus is a battery module comprising at least two battery cells, and wherein one or more of the laminates is positioned between the two battery cells.
Aspect 63: The apparatus of aspect 57, wherein the apparatus is a battery pack comprising at least two of the battery modules, and wherein one or more of the laminates is positioned between the two battery modules.
Aspect 64: The apparatus of aspect 57, wherein the apparatus is a battery box comprising an outer surface, an inner surface, and an inner volume.
Aspect 65: The apparatus of aspect 64, wherein the one or more of laminates cover at least a portion of the outer surface, at least a portion of the inner surface, or both.
Aspect 66: The apparatus of aspect 64 or 65, wherein the inner volume is configured to enclose the compression pad, the battery cell, the battery module, or the battery pack.
Aspect 67: The apparatus of aspect 66, wherein the inner volume comprises the compression pad, the battery cell, the battery module, the battery pack, or any combination thereof.
Aspect 68: The apparatus of any one of aspects 57 to 67, wherein the compression pad, the battery cell, the battery module, the battery pack, or the battery box is comprised in a vehicle, the vehicle comprising one or more electric motors.
Aspect 69: The apparatus of aspect 68, wherein the vehicle is an automobile, an aircraft, a train, a motorcycle, a watercraft, or a spacecraft.
Aspect 70: The apparatus of aspect 51, wherein the apparatus is a cable.
Aspect 71: The apparatus of aspect 70, wherein the cable has a length and a width, and wherein the length is longer than the width.
Aspect 72: The apparatus of aspect 70 or 71, wherein the cable is electrically-conductive.
Aspect 73: The apparatus of any one of aspects 70 to 72, wherein the cable comprises a diameter of 0.0003 inches to 10 inches, preferably 0.001 inches to 1 inch.
Aspect 74: The apparatus of any one of aspects 70 to 73, wherein the cable is comprised in a missile, rocket, artillery, manned aircraft, unmanned aircraft, terrestrial vehicle, sea vehicle, or spacecraft.
Aspect 75: The apparatus of aspect 74, wherein the vehicle is a spacecraft or an aircraft.
Aspect 76: The apparatus of any one of aspects 51 to 75, wherein the one or more laminates is capable of maintaining the temperature of the apparatus at 500° C. or less when the front surface of the laminate is exposed to a temperature greater than 500° C., preferably 500° C. to 1,500° C., or more preferably 700° C. to 1,200° C., for 1 minute to 90 minutes, preferably for at least 5 minutes.
Aspect 77: A method of thermally protecting an apparatus of any one of aspects 51 to 76, the method comprising coupling the laminate of any of aspects 1 to 50 to the apparatus.
Aspect 78: The method of aspect 77, wherein the laminate is positioned relative to the apparatus such that the front surface of the laminate is disposed further from the apparatus than the rear surface of the laminate.
Aspect 79: The method of aspect 78, wherein the front surface of the laminate is subjected to a temperature of greater than 500° C. to 1,500° C. for a time period of 1 minute to 90 minutes, preferably at least 5 minutes, and the temperature of the apparatus does not exceed 500° C. during the time period.
Aspect 80: The method of aspect 78, wherein the front surface of the laminate is subjected to a temperature of 700° C. to 1,200° C. for a time period of 1 minute to 90 minutes, preferably at least 5 minutes, and the temperature of the apparatus does not exceed 500° C. during the time period.
Aspect 81: The laminate of any one of aspects 1-50, wherein the flame-retardant layer comprises a first flame-retardant layer and a second flame retardant layer, and the first and second flame-retardant layers are disposed on opposing sides of the aerogel layer.
Aspect 91: A laminate comprising a reinforcing layer comprising fibers, a flame-retardant layer having a flammability rating compliant with UL94 5VA, UL94 5VB, or UL94 V-0, a porous, thermally-insulative layer, and a (e.g., optional) heat-dispersing layer comprising at least 90%, by weight, of a metal or graphite, wherein a thickness of the laminate is less than or equal to 25.4 mm (e.g., less than or equal to 5 mm).
Aspect 92: The laminate of aspect 91, wherein the porous, thermally-insulative layer comprises an aerogel layer.
Aspect 93: The laminate of aspect 91 or 92, wherein the fibers of the reinforcing layer comprise glass fibers or basalt fibers.
Aspect 94: The laminate of any of aspects 91-93, wherein the fibers of the reinforcing layer are woven.
Aspect 95: The laminate of any of aspects 91-94, wherein the laminate has opposing front and back surfaces, and each of the reinforcing layer, the flame-retardant layer, and the heat-dispersing layer is positioned closer to the front surface than is the aerogel layer.
Aspect 96: The laminate of any of aspects 91-95, wherein the flame-retardant layer is positioned between the reinforcing layer and the aerogel layer.
Aspect 97: A laminate comprising an ejecta-mitigating layer, a flame-retardant layer having a flammability rating compliant with UL94 5VA, UL94 5VB, or UL94 V-0, and a porous, thermally-insulative layer, wherein the laminate has opposing front and back surfaces, and the ejecta-mitigating layer defines at least a majority of the front surface.
Aspect 98: The laminate of aspect 97, wherein the porous, thermally-insulative layer comprises an aerogel layer.
Aspect 99: The laminate of aspect 97 or 98, wherein the ejecta-mitigating layer comprises at least 90%, by weight, of a metal.
Aspect 100: The laminate of aspect 99, wherein the metal of the ejecta-mitigating layer comprises titanium.
Aspect 101: The laminate of aspect 97 or 98, wherein the ejecta-mitigating layer comprises fibers.
Aspect 102: The laminate of aspect 101, wherein the fibers of the ejecta-mitigating layer comprise glass fibers or basalt fibers.
Aspect 103: The laminate of aspect 101 or 102, wherein the fibers of the ejecta-mitigating layer are woven.
Aspect 104: The laminate of any of aspects 91-103, wherein the flame-retardant layer is inorganic-based.
Aspect 105: The laminate of any of aspects 91-104, wherein the flame-retardant layer comprises a paper.
Aspect 106: The laminate of any of aspects 91-105, wherein the flame-retardant layer comprises at least 90%, by weight, of a silicate.
Aspect 107: The laminate of any of aspects 91-105, wherein the flame-retardant layer comprises at least 90%, by weight, of a ceramic.
Aspect 108: The laminate of any of aspects 91-107, wherein a thickness of the flame-retardant layer is from 0.05 mm to 0.8 mm.
Aspect 109: The laminate of any of aspects 91-108, wherein the porous, thermally-insulative layer comprises at least 50%, by weight, of polyimide.
Aspect 110: The laminate of any of aspects 91-109, wherein the flammability rating of the laminate is compliant with UL94 5VA, UL94 5VB, or UL94 V-0.
Aspect 111: The laminate of any of aspects 91-110, comprising one or more adhesive layers coupled to the porous, thermally-insulative layer, including a first adhesive layer disposed between the flame-retardant layer and the porous, thermally-insulative layer.
Aspect 112: The laminate of any of aspects 91-111, comprising a second flame-retardant layer, wherein the flame-retardant layers are disposed on opposing sides of the porous, thermally-insulative layer.
Aspect 113: An apparatus comprising the laminate of any of aspects 91-112, comprising the laminate coupled to the apparatus.
Aspect 114: The apparatus of aspect 113, wherein the apparatus is a compression pad, a battery cell, a battery module, a battery pack, or a battery box.
Aspect 115: The apparatus of aspect 113, wherein the apparatus is an electrically-conductive cable.

### EXAMPLES

The present invention will be described in greater detail by way of specific examples. The following examples are offered for illustrative purposes only and are not intended to limit the invention in any manner. Those of ordinary skill in the art will readily recognize a variety of noncritical parameters, which can be changed or modified to yield essentially the same results.

### Example 1

### Testing of Flame and Thermal Barrier Laminates

Materials. A copper bar of 12 inches×1.6 inches×0.2 inches was obtained from McMaster Carr. The AeroZero (AZ) film (6.5-mils-thick) used was manufactured by Blueshift Materials Inc., and the flame-retardant barrier material used was 3M FRB WT145 (5.8-mils-thick), which was manufactured by 3M. Laminate test samples were assembled using a pressure sensitive silicone adhesive, SA6101LR, manufactured by FLEXcon.

Test set-up. Testing of the efficacy of the flame and thermal barrier samples was conducted using bare copper bar as the test substrate. The copper bar was clamped to a support stand in a horizontal position. A thermocouple was attached to the center of the copper bar using Kapton tape to secure it. The test samples were wrapped around the copper bar before exposure to the flame.

The test sample was wrapped around 2-inches of the 12-inch copper bar, with the tip of the thermocouple directly underneath the test sample and in direct contact with the copper bar. The test sample was adhered to the copper bar using a silicone pressure sensitive adhesive. A flame source (Bunsen burner) having a flame temperature set to 700° C. was placed at a 1.5-inch distance from the test sample such that the flame directly contacted the test sample, which was positioned horizontally. The temperature from the thermocouple was recorded in 30-second intervals for 10 minutes.

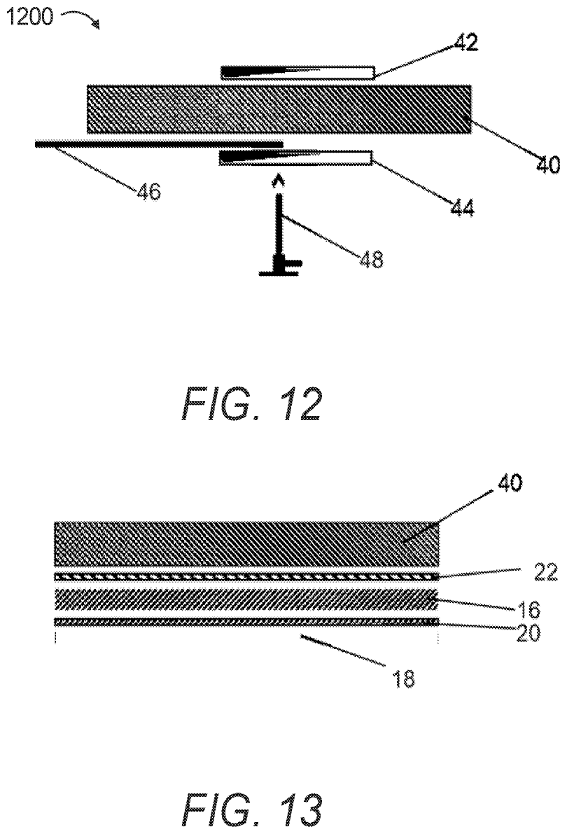

The test configuration is illustrated in FIG. 12. As shown, test set-up 1200 included copper bar 40, test samples 42, 44, thermocouple 46, and flame source 48. The layup of the flame and thermal barrier test samples 42, 44 is shown in FIG. 13. Each included one or more AeroZero aerogel layers as thermally-insulative layer(s) 16, with adhesive layers 20, 22 directly attaching the aerogel layer(s) to copper bar 40 and flame-retardant layer 18. Flame-retardant layer 18 faced flame source 48. Several samples were tested, and their specific lay-ups are provided in TABLE 1.

TABLE 1
Lay-ups of Flame and Thermal Barrier Test Samples

| Test | | |
|---|---|---|
| Sample | Sample description | Thickness (mm) |
| Control | No barrier | NA |
| FRB only | Single layer FRB WT-145 | 0.15 |
| AZ only | Single layer AeroZero film | 0.16 |
| 1AZ + FRB | Single layer FRB WT-145 + single | 0.33 |
| | layer AeroZero film | |
| 2AZ + FRB | Single layer FRB WT-145 + double | 0.52 |
| | layer AeroZero (AZ) film | |

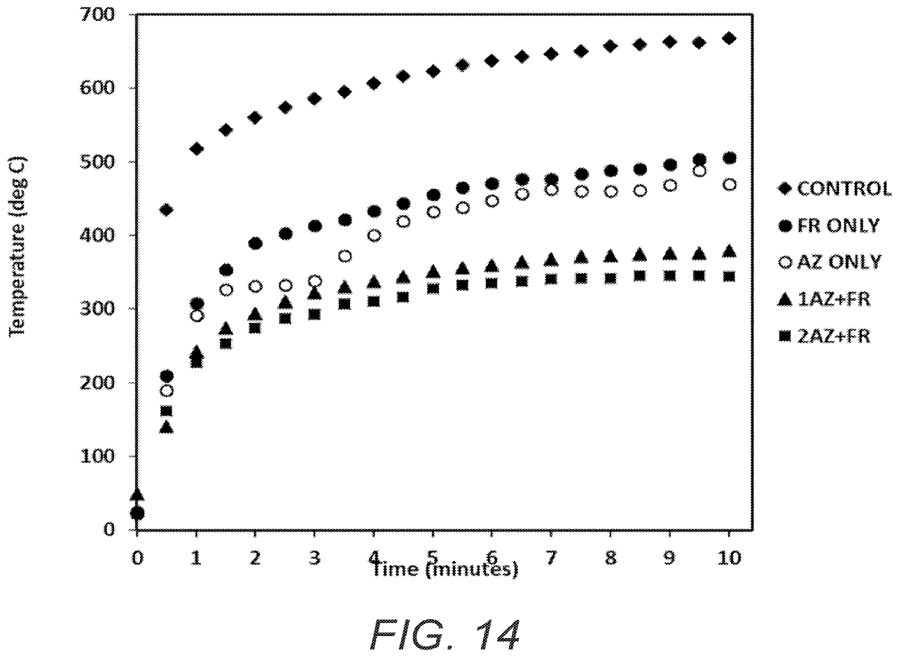

The thermal profiles of the samples tested are shown in FIG. 14. For each sample, temperatures of the copper bar after 5 min and after 10 min of the sample being exposed to the flame are provided in TABLE 2. These temperatures were compared to the control sample, i.e., the copper bar with no barrier. The tests showed a significant reduction in the temperature of the copper bar when one or two thermally-insulative layers (here, an AeroZero film) were combined with a flame-retardant layer (here, FRM WT-145), and thus a surprising synergy between the thermally-insulative layer(s) and the flame-retardant layer.

TABLE 2
Copper Bar Temperature During Sample Exposure to Flame

| | Temp after | Delta | Temp after | Delta |
|---|---|---|---|---|
| | 5 min | Temp | 10 min | Temp |
| Sample | [° C.] | [° C.] | [° C.] | [° C.] |
| Control | 623 | — | 667 | — |
| FRB only | 455 | 168 | 506 | 161 |
| AZ only | 432 | 191 | 469 | 198 |
| 1AZ + FRB | 351 | 272 | 380 | 287 |
| 2AZ + FRB | 313 | 310 | 335 | 332 |

### Examples 2-7

### Testing of Flame and Thermal Barrier Laminates

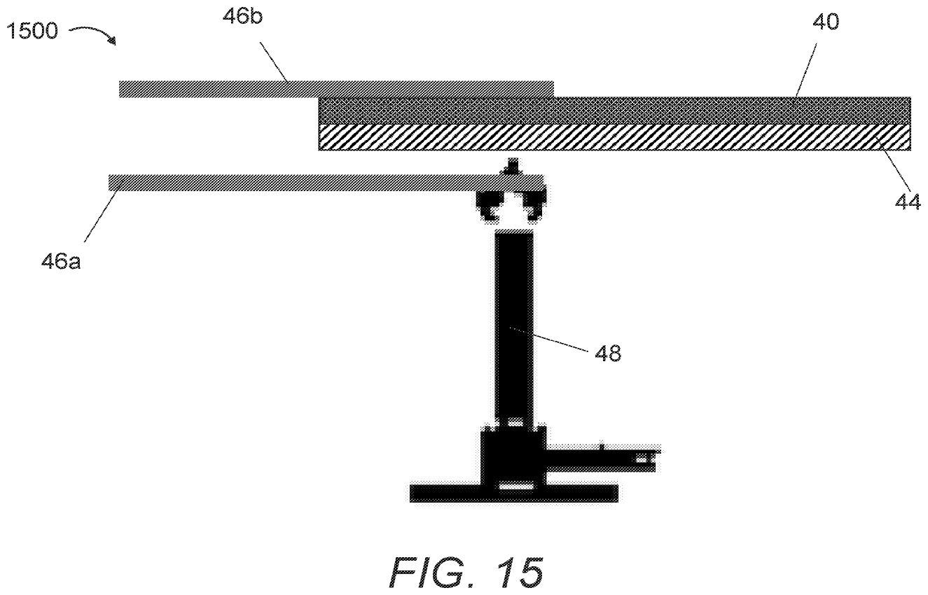

1000° C. Flame Test set-up. Further testing of the flame and thermal barrier samples was conducted using test set-up 1500 shown in FIG. 15. Test set-up 1500 was substantially similar to test set-up 1200 with the following exceptions. Here, the flame was 3-inches tall, 2-inches wide, and had a temperature of 1,000° C.±30° C., with the base of the flame being positioned 2.5 inches away from test sample 44. Further, some tests were conducted with no test substrate and others were conducted with test substrates including 8 inch×8 inch plates of aluminum, steel, and carbon fiber composite. In tests using a test substrate, instead of two samples, 42, 44, only one sample 44 was adhered to the test substrate on its flame-facing side. Finally, two thermocouples were used—46a and 46b. Thermocouple 46a was in direct contact with the flame to measure flame temperature, and thermocouple 46b was placed on the non-flame-facing (i.e., “cold”) side of the laminate test sample (if no test substrate was used) or the test substrate. All thermal profiles described in Examples 2-7 are based on temperatures recorded by thermocouple 46b.

### Example 2

Flame and thermal barrier laminate test samples having the lay-ups shown in TABLE 3 were exposed to the 1,000° C. flame for 600 seconds (10 minutes). The laminate test samples were not adhered to a test substrate. In this example, laminates with flame-retardant layers (“FRBs”) alone were compared to laminates in which the FRBs were combined with thermally-insulative layers. The tested FRBs were of type FRB NT381, manufactured by 3M.

TABLE 3
Lay-ups of Flame and Thermal Barrier Test Samples

| | | FRB | Laminate |
|---|---|---|---|
| | | Thickness | Thickness |
| Sample | FRB Type | (mm) | (mm) |
| FRB/FRB | NT381 | 0.38 | 0.79 |
| FRB/AeroZero/AeroZero/FRB | NT381 | 0.38 | 1.17 |

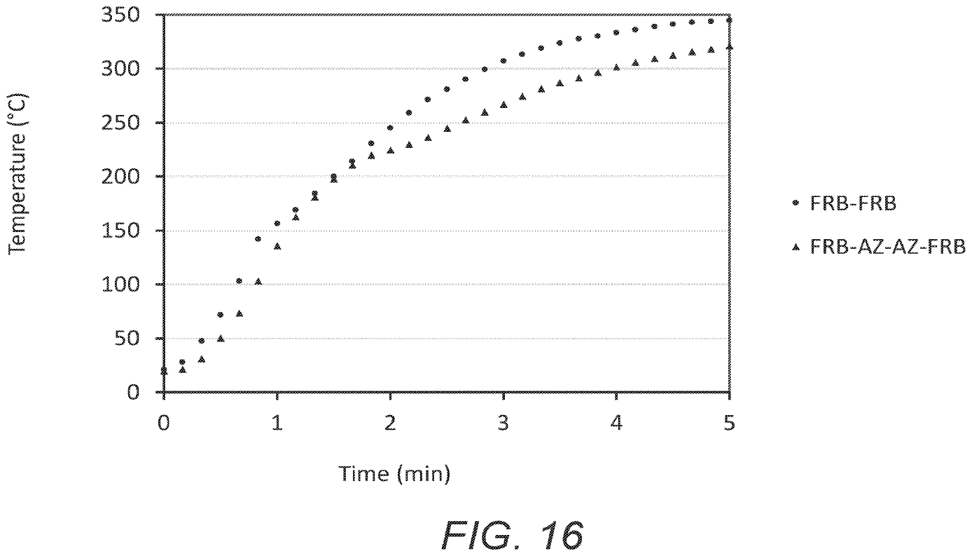

The thermal profiles of TABLE 3's samples are provided in FIG. 16. As shown, the laminate including FRBs and thermally-insulative layers gave both a lower primary heating rate and a lower temperature after 5 minutes (312° C. vs. 341° C.) than did the laminate with FRBs alone.

### Example 3

Flame and thermal barrier laminate test samples having the lay-ups shown in TABLE 4 were exposed to the 1,000° C. flame for 25 minutes. The laminate test samples were not adhered to a test substrate. In this example, one of the samples included an additional heat-dispersing layer—a 0.05 mm-thick graphite layer—disposed between the flame-facing FRB and one of the thermally-insulative layers.

TABLE 4
Lay-ups of Flame and Thermal Barrier Test Samples

| | | FRB | Laminate |
|---|---|---|---|
| | | Thickness | Thickness |
| Sample | FRB Type | (mm) | (mm) |
| FRB/AeroZero/AeroZero/FRB | NT381 | 0.38 | 1.17 |
| FRB/Graphite/ | NT381 | 0.38 | 1.24 |
| AeroZero/AeroZero/FRB | | | |

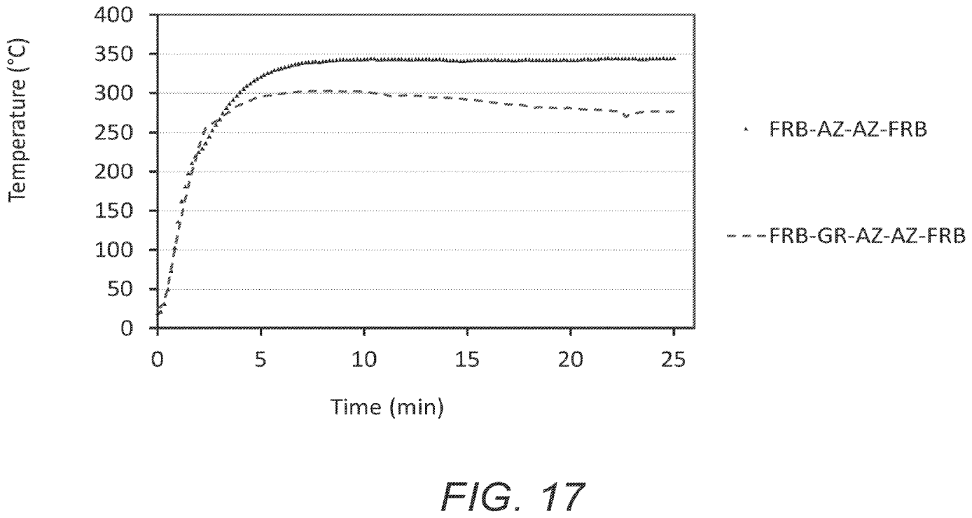

The thermal profiles of TABLE 4's samples are provided in FIG. 17. The data shows that the addition of a heat-dispersing layer between the flame-facing FRB and the thermally-insulative layers provides for a further reduction in the laminate's cold-side temperature. While the primary heating rate for the laminate including the heat-dispersing layer was similar to the primary heating rate for the laminate without the heat-dispersing layer for the first 3 minutes or so, after 3 minutes, the laminate including the heat-dispersing layer outperformed the laminate without the heat-dispersing layer, including in terms of heating rate. These improvements are quantified in TABLE 5, which provides the laminate cold-side temperatures at 5 minutes, 10 minutes, and 25 minutes of the sample's exposure to the flame.

TABLE 5
Laminate Cold-Side Temperature
During Sample Exposure to Flame

| | Temp after | Temp after | Temp after |
|---|---|---|---|
| | 5 min | 10 min | 25 min |
| Sample | [° C.] | [° C.] | [° C.] |
| FRB/AeroZero/AeroZero/FRB | 312 | 343 | 344 |
| FRB/Graphite/ | 290 | 302 | 276 |
| AeroZero/AeroZero/FRB | | | |

### Example 4

Flame and thermal barrier laminate test samples of three different thicknesses (0.57 mm, 0.70 mm, and 1.17 mm) were adhered to an 8-inch×8-inch low carbon steel plate of 0.7-mm thickness and exposed to the 1,000° C. flame for 600 seconds (10 minutes). The laminate test samples' lay-ups are provided in TABLE 6.

TABLE 6
Lay-ups of Flame and Thermal Barrier Test Samples

| | | FRB | Laminate |
|---|---|---|---|
| | | Thickness | Thickness |
| Sample | FRB Type | (mm) | (mm) |
| FRB/AeroZero | NT-381 | 0.38 | 0.57 |
| FRB/AeroZero/AeroZero/FRB | WT-145 | 0.13 | 0.70 |
| FRB/AeroZero/AeroZero/FRB | NT-381 | 0.38 | 1.17 |

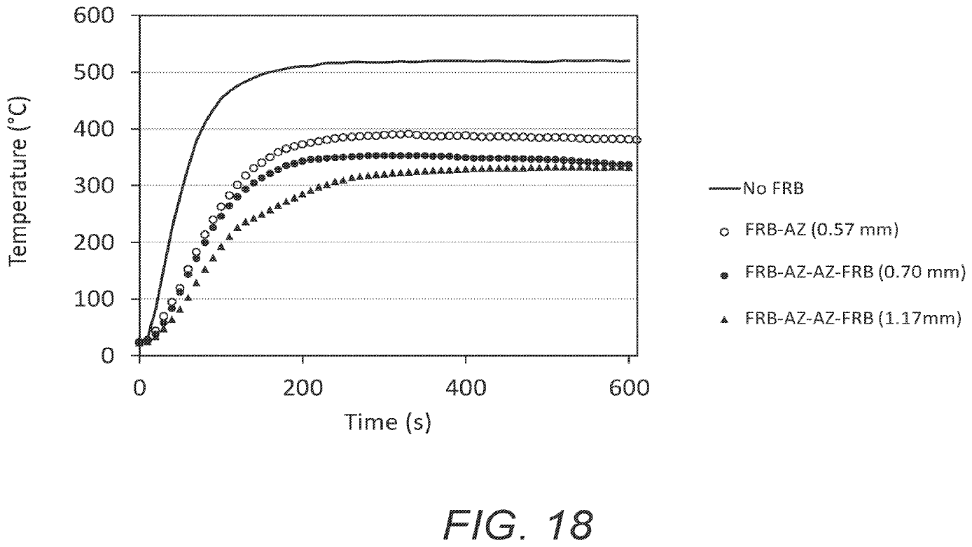

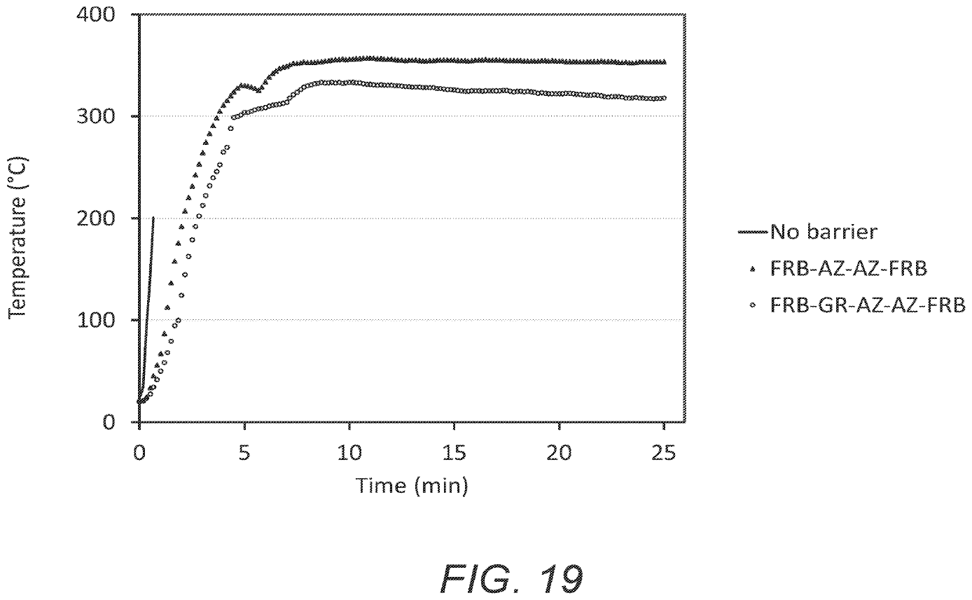

The thermal profiles of TABLE 6's samples are provided in FIG. 18, along with the thermal profile of a control that consisted of the steel plate with no laminate adhered thereto (“No FRB”). As the data shows, both the primary heating rate (measured within the first 200 seconds) and the maximum temperature (measured at 600 seconds) of the cold side of the substrate decreased as laminate-thickness increased. Notably, the maximum temperature of the cold side of the substrate for both the 0.70 mm-thick and 1.17 mm-thick laminates remained below 350° C. during the 600 seconds (10 minutes) of flame exposure.

### Example 5

Flame and thermal barrier laminate test samples, including one having a heat-dispersing, 0.05 mm-thick graphite layer and one without such a heat-dispersing layer, were adhered to an 8-inch×8-inch carbon fiber composite plate of 1.0-mm thickness and exposed to the 1,000° C. flame for 25 minutes. The laminate test samples' lay-ups are provided in TABLE 7.

TABLE 7
Lay-ups of Flame and Thermal Barrier Test Samples

| | | FRB | Laminate |
|---|---|---|---|
| | | Thickness | Thickness |
| Sample | FRB Type | (mm) | (mm) |
| FRB/AeroZero/AeroZero/FRB | NT-381 | 0.38 | 1.17 |
| FRB/Graphite/ | NT-381 | 0.38 | 1.24 |
| AeroZero/AeroZero/FRB | | | |

The thermal profiles of TABLE 7's laminates are provided in FIG. 19, along with the thermal profile of a control that consisted of the carbon fiber composite plate with no laminate adhered thereto (“No FRB”). With no protective laminate, the carbon fiber composite plate started to burn and generate heavy smoke within 10 seconds of exposure to the flame. The cold-side temperature of the carbon fiber composite plate rose rapidly, reaching 200° C. within 40 seconds. The test was stopped due to the high smoke generation and the carbon fiber composite plate's decomposition. When protected with the flame and thermal barrier laminate that did not include a heat-dispersing layer, the primary heating rate was significantly lower: the cold side of the carbon fiber composite plate took around 2 minutes to reach 200° C. And the maximum temperature of the cold side of the carbon fiber composite plate was 355° C. after 10 minutes of flame exposure, which did not increase further during the 25-minute duration of the test.

The flame and thermal barrier laminate including the heat-dispersing layer showed increased performance in terms of both primary heating rate and maximum temperature of the cold side of the carbon fiber composite plate. In particular, the primary heating rate shifted slightly to the right, reaching 200° C. after 2.8 minutes, and the maximum temperature of the cold side of the carbon fiber composite plate was 333° C. during the 25-minutes of flame exposure. These improvements are further quantified in TABLE 8, which provides substrate cold-side temperatures at 5 minutes, 10 minutes, and 25 minutes of the sample's exposure to the flame.

TABLE 8
Substrate Cold-Side Temperature
During Sample Exposure to Flame

| | Temp after | Temp after | Temp after |
|---|---|---|---|
| | 5 min | 10 min | 25 min |
| Sample | [° C.] | [° C.] | [° C.] |
| FRB/AeroZero/AeroZero/FRB | 324 | 356 | 353 |
| FRB/Graphite/ | 299 | 333 | 317 |
| AeroZero/AeroZero/FRB | | | |

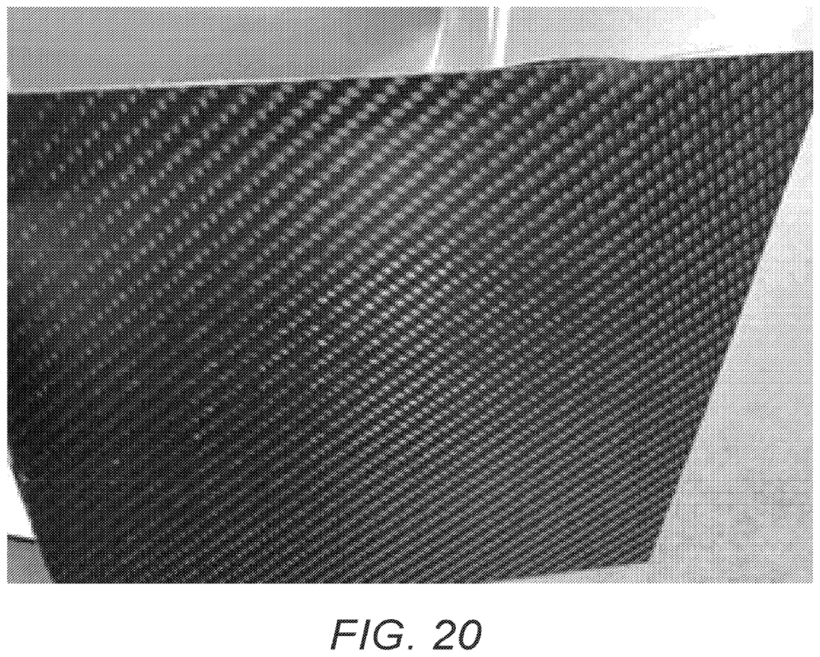

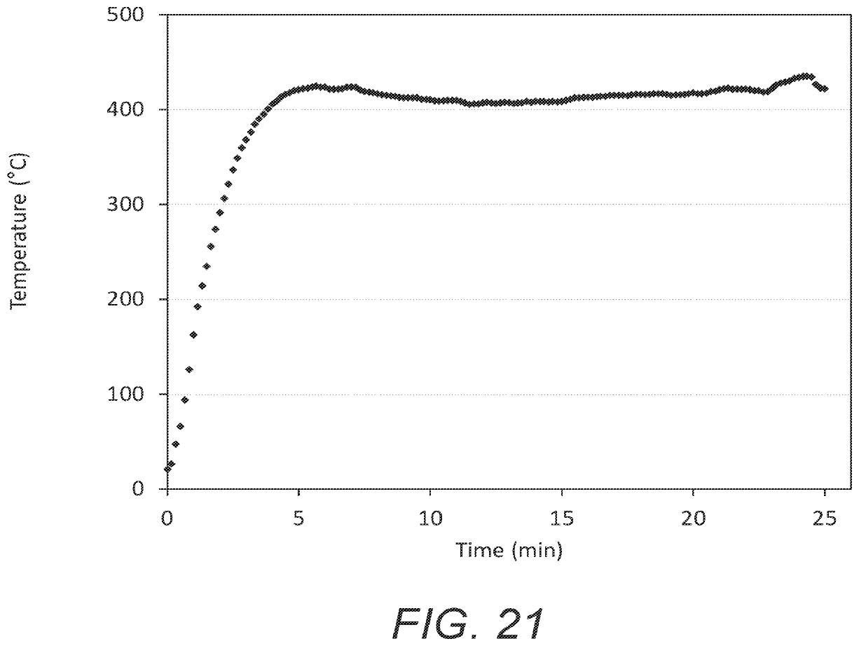

Additionally and as shown in FIG. 20, for both of TABLE 7's laminates, there was no burn-through of the carbon fiber composite plate during the test.

### Example 6

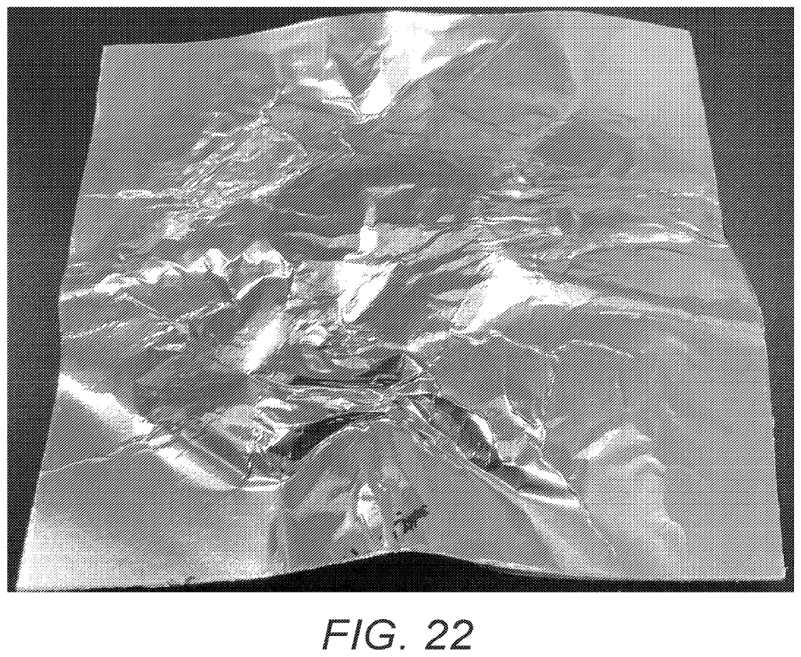

The 1.17-mm thick, FRB/AeroZero/AeroZero/FRB flame and thermal barrier laminate of TABLE 3 was adhered to an 8-inch×8-inch aluminum sheet having a 0.025-mm (1-mil) thickness and exposed to the 1,000° C. flame for 25 minutes. The thermal profile for this laminate is provided in FIG. 21. As shown, this thermal profile includes a gradual rise in the temperature of the aluminum sheet, which reached a maximum of 325° C. during the 25-minute test: well below the melting point of aluminum. Indeed, no burn-through of the aluminum sheet was observed during the test, which is shown in FIG. 22.

### Example 7

The thermal conductivities of several flame and thermal barrier laminates was tested following the ASTM C518 test method: “Standard Test Method for Steady-State Thermal Transmission Properties by Means of the Heat Flow Meter Apparatus.” The instrument used was a Fox 50 heat flow meter manufactured by TA instruments. The tested laminates' lay-ups, thermal conductivities, and densities are provided in TABLE 9.

TABLE 9
Properties of Flame and Thermal Barrier Test Samples

| | Thermal | |
|---|---|---|
| | Conductivity | Density |
| Sample | [W/m · K] | [g/cm³] |
| AeroZero | 0.034 | 0.27 |
| FRB WT-145 | 0.113 | 1.41 |
| FRB NT-381 | 0.195 | 1.42 |
| FRB WT-145/AeroZero | 0.058 | 0.87 |
| FRB NT-381/AeroZero | 0.083 | 1.12 |
| FRB/AeroZero/AeroZero/FRB | 0.059 | 0.89 |
| FRB/AeroZero/AeroZero/FRB | 0.083 | 1.09 |

### Examples 8-9

### Testing of Flame and Thermal Barrier Laminates Including Ejecta-Mitigating Layers

Materials. Flame and thermal barrier laminates including layers for ejecta mitigation were prepared, each including aerogel layers, FRB layers, and, for some laminates, a heat-dispersing graphite layer, where those layers were laminated to one another and to one or more ejecta-mitigating layer using pressure sensitive silicone adhesive, SA6101LR. The aerogel layers were 6.5-mil-thick AZ films, and the FRB layers were either 5.8-mil-thick WT-145 or 15-mil-thick NT-381. Two different ejecta-mitigating layers were used. The first was a woven fiberglass layer having S2-glass fibers with a 6781 weave style manufactured by Fibre Glast Development Corp. The second was a plain weave basalt fabric made of continuous basalt filament roving, manufactured by Canadian Basalt. The properties of these ejecta-mitigating layers are provided in TABLE 10.

TABLE 10
Properties of Ejecta-Mitigating Layers

| | Woven Fiberglass | Basalt Fabric |
|---|---|---|
| Thickness (mm) | 0.25 | 0.11 |
| Basis weight (g/m²) | 305 | 108 |
| Density (g/cm³) | 1.20 | 0.99 |

Measurement Methods. Sample laminate thicknesses were measured by applying method C of ASTM D374/D374M-16: “Standard Test Methods for Thickness of Solid Electrical Insulation.” For each sample laminate, five circles of 2-inch diameter were cut from the laminate, and the thickness was measured at three locations on each circle. The reported sample thickness is an average of these 15 measurements. The micrometer used was a Mitutoyo electronic thickness gage (no. 547-526S).

Density was calculated following ASTM 202-17: “Standard Test Methods for Sampling and Testing Untreated Paper Used for Electrical Insulation.” For each sample laminate, five circles of 2-inch diameter were cut from the laminate. The mass of each circle was measured using an analytical balance and divided by the circle's volume to obtain its density. The reported density is an average of these five measurements.

The basis weight of each sample laminate was obtained from ten 2-inch diameter circles cut from the laminate. The mass of each of these circles was measured using an analytical balance following ASTM 202-17: “Standard Test Methods for Sampling and Testing Untreated Paper Used for Electrical Insulation” and divided by the circle's surface area to determine its basis weight. The reported basis weight is an average of these ten measurements.

Thermal conductivity was obtained using a FOX 50 heat flow meter following ASTM C518-10: “Standard Test Method for Steady-State Thermal Transmission Properties by Means of the Heat Flow Meter Apparatus.” Circles of 2-inch diameter were cut from each sample laminate and stacked until a 3-mm-thick stack with uniform surfaces was obtained. The stack was placed between the plates of the FOX 50 analyzer. The hot and cold plate temperatures were maintained at 35° C. and 15° C. respectively. Thus, the thermal conductivity was measured at a mean temperature of 25° C.

Flame Test Procedure. Each of the sample laminates tested was 8 in by 8 in, and FIG. 15's test set-up was used with no test substrate 40. Gas flow rate to flame source 48 and the distance between the flame and sample laminate 44 was maintained across the tests. During the tests, the bottom thermocouple 46a recorded temperatures of 1,000±30° C. Each of the tests was run for 10 minutes, during which the cold side temperature of the sample laminate was recorded using thermocouple 46b.

### Example 8

Test Sample Lay-ups. Specific lay-ups of some of the tested laminates (S1-S4) are provided in TABLE 11, along with the properties of those laminates. The sample laminates without ejecta layers (S1 and S2) were included for comparison purposes.

TABLE 11
Lay-ups and Properties of Flame and Thermal Barrier Test Samples

| | Laminate | | Basis | Thermal |
|---|---|---|---|---|
| | Thickness | Density | Weight | Conductivity |
| Sample | (mm) | (g/cm³) | (g/m²) | (W/m · K) |
| 1. NT381/AZ/AZ/NT381 | 1.17 | 1.09 | 1264 | 0.084 |
| 2. NT381/graphite/ | 1.24 | 1.14 | 1345 | 0.089 |
| AZ/AZ/NT381 | | | | |
| 3. fiberglass/NT381/ | 1.50 | 1.18 | 1759 | 0.091 |
| graphite/AZ/AZ/NT381 | | | | |
| 4. basalt/NT381/ | 1.29 | 1.19 | 1548 | 0.093 |
| graphite/AZ/AZ/NT381 | | | | |

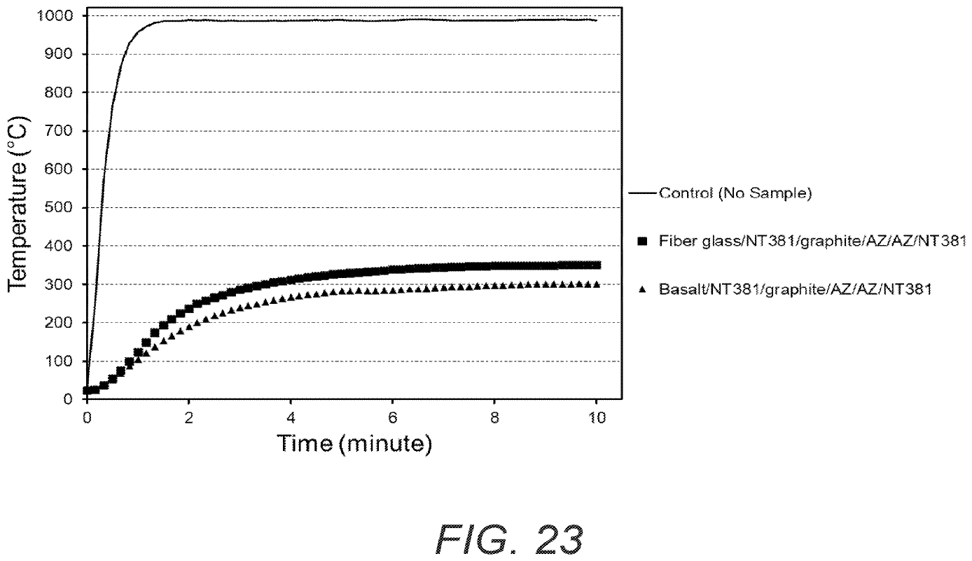

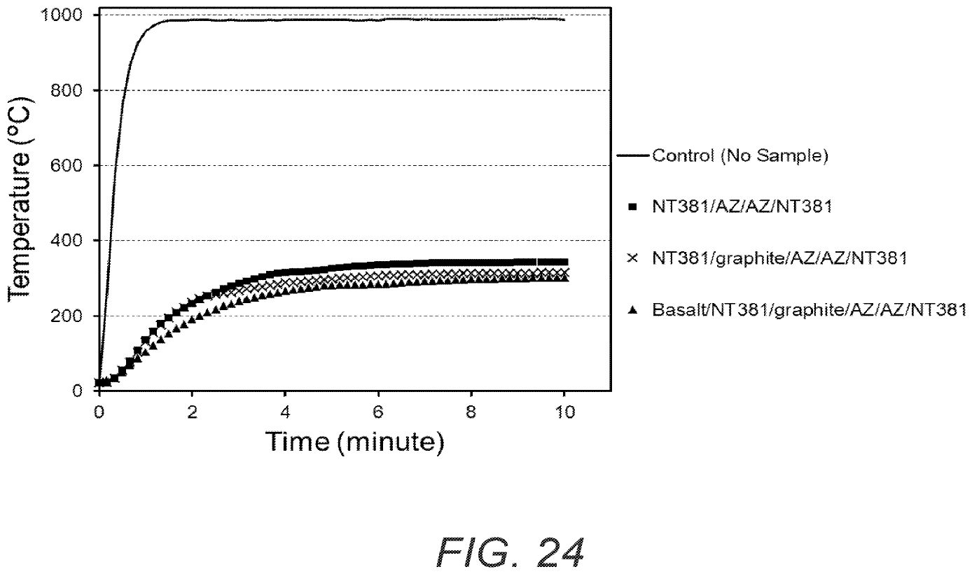

Results. The thermal profiles of the ejecta-layer-including sample laminates (S3 and S4) are shown in FIG. 23, and the thermal profiles of the non-ejecta-layer-including sample laminates (S1 and S2) are shown in FIG. 24. For each of the sample laminates, the laminate's cold-side temperature and difference between the laminate's hot-side temperature and the cold-side temperature at 5 and 10 minutes are reported in TABLE 12.

TABLE 12
Laminate Temperatures During Sample Exposure to Flame

| | Cold- | Delta | Cold- | Delta |
|---|---|---|---|---|
| | Side | Temp @ | Side | Temp @ |
| | @ 5 | 5 min | @ 10 | 10 min |
| Sample | min (° C.) | (° C.) | min (° C.) | (° C.) |
| Control (No Sample) | 988 | NA | 988 | NA |
| 1. NT381/AZ/AZ/NT381 | 326 | 662 | 343 | 645 |
| 2. NT381/graphite/ | 299 | 689 | 315 | 673 |
| AZ/AZ/NT381 | | | | |
| 3. fiberglass/NT381/ | 328 | 660 | 350 | 638 |
| graphite/AZ/AZ/NT381 | | | | |
| 4. basalt/NT381/ | 282 | 706 | 301 | 687 |
| graphite/AZ/AZ/NT381 | | | | |

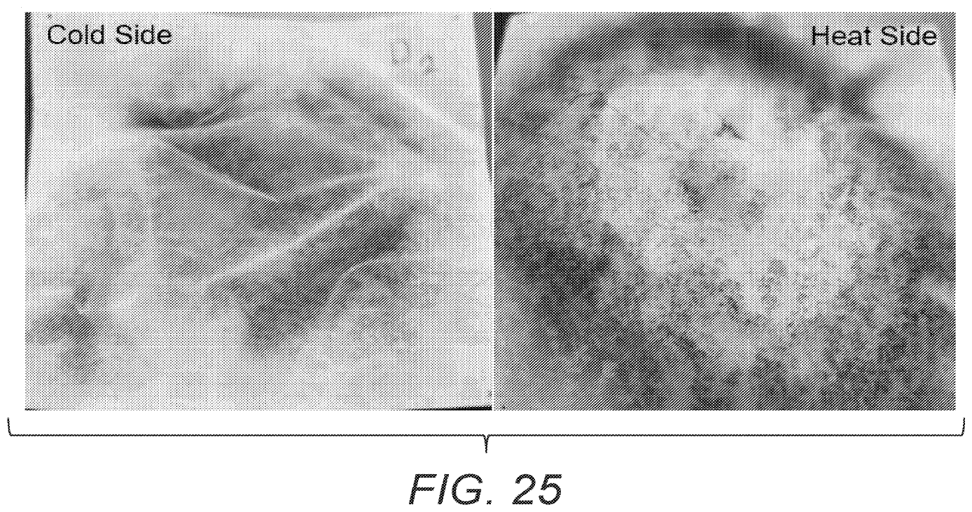

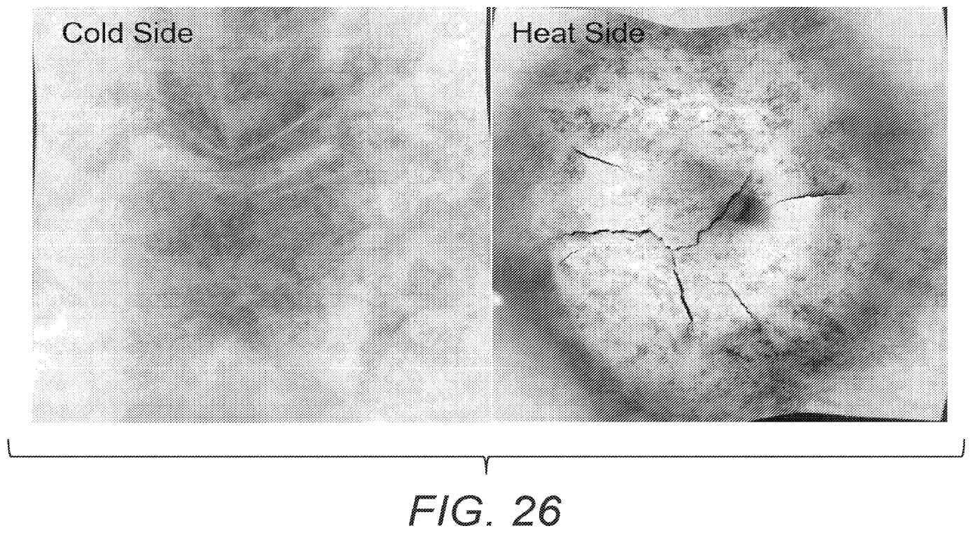

Finally, FIGS. 25-28 show the hot and cold sides of the sample laminates, S1-S4, respectively, after 10 minutes of flame exposure.

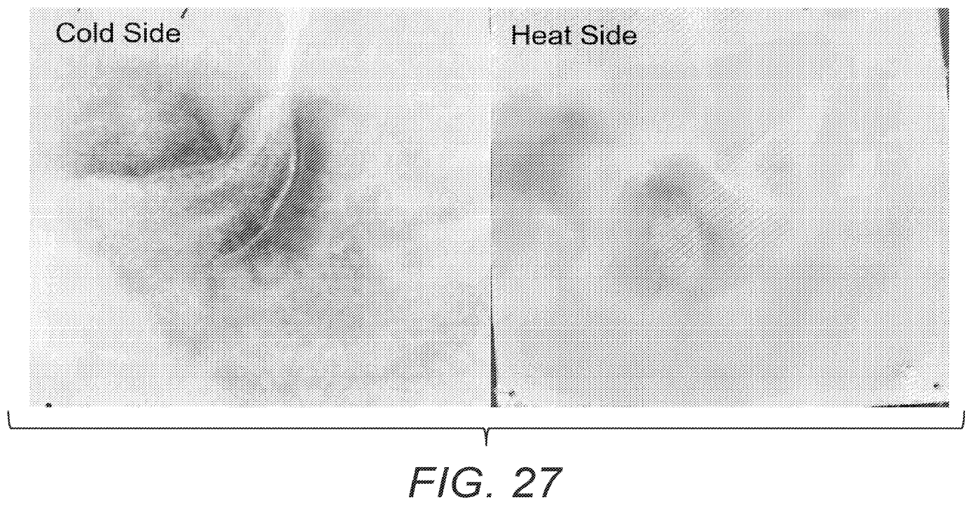

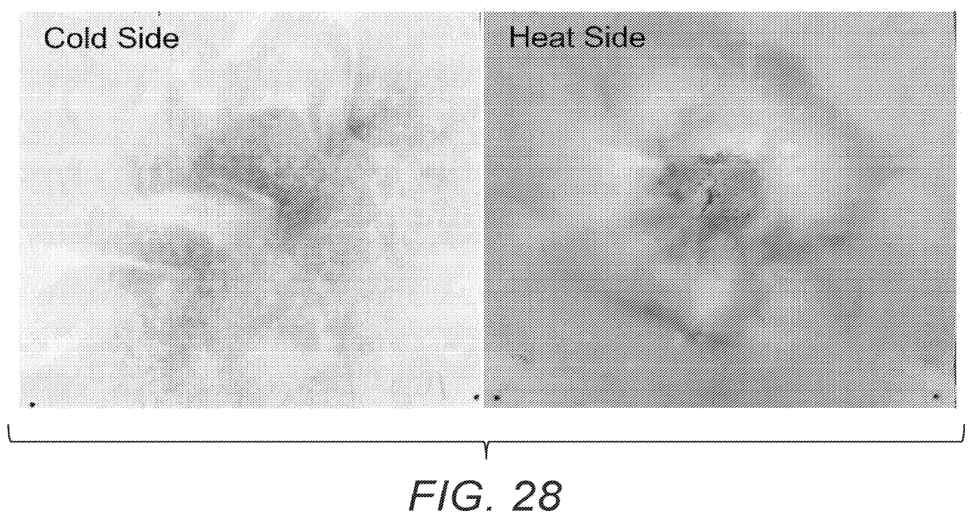

Discussion Starting with FIGS. 25 and 26, the sample laminates without ejecta layers (S1 and S2) showed cracking on the hot side after 10 minutes of flame exposure. The sample laminates including ejecta layers, on the other hand, better maintained their structural integrity after 10 minutes of flame exposure. Indeed, as shown in FIGS. 27 and 28, the ejecta-layer-including laminates showed no hot-side cracking and minimal damage to their cold sides with no burn-through.

As between the ejecta-layer-including sample laminates, the sole difference was that one (S3) included a fiberglass ejecta layer on its hot side, and the other (S4) included a basalt fabric ejecta layer on its hot side. Despite the laminate having the fiberglass ejecta layer being thicker than the laminate having the basalt fabric ejecta layer (1.50 mm vs. 1.29 mm; due to the fiberglass layer having a larger thickness than the basalt fabric layer), the laminate having the basalt fabric ejecta layer outperformed the laminate having the fiberglass ejecta layer based on cold-side temperature (282° C. vs. 328° C. @ 5 minutes and 301° C. vs. 350° C. @ 10 minutes) and heating rate (FIG. 23).

And as evidenced by FIG. 24 and TABLE 12, the laminate having the basalt fabric ejecta layer (S4) outperformed—in terms of cold-side temperature—the otherwise similar sample laminate that did not include an ejecta layer (S2). Indeed, adding a basalt-fabric layer to S2 (to make S4) reduced the cold-side temperature from 299° C. to 282° C. after 5 minutes of flame exposure and from 315° C. to 301° C. after 10 minutes of flame exposure.

### Example 9

Test Sample Lay-ups. Flame and thermal barrier sample laminates having the lay-ups and properties shown in TABLE 13 were exposed to the 1,000° C. flame for 10 minutes.

TABLE 13
Lay-ups and Properties of Flame and Thermal Barrier Test Samples

| | Laminate | | Basis | Thermal |
|---|---|---|---|---|
| | Thickness | Density | Weight | Conductivity |
| Sample | (mm) | (g/cm³) | (g/m²) | (W/m · K) |
| 5. basalt/AZ | 0.28 | 0.63 | 175 | 0.048 |
| 6. basalt/NT381/ | 1.12 | 0.93 | 1047 | 0.065 |
| graphite/AZ/AZ/AZ | | | | |
| 4. basalt/NT381/ | 1.29 | 1.19 | 1548 | 0.093 |
| graphite/AZ/AZ/NT381 | | | | |
| 7. basalt/basalt/ | 1.11 | 1.02 | 1147 | 0.083 |
| NT381/graphite/AZ/AZ | | | | |
| 8. basalt/basalt/NT381/ | 1.21 | 0.99 | 1203 | 0.069 |
| graphite/AZ/AZ/AZ | | | | |
| 9. basalt/basalt/NT381/ | 1.40 | 1.20 | 1682 | 0.091 |
| graphite/AZ/AZ/NT381 | | | | |

The aim of these tests was to further investigate the performance of basalt-fabric ejecta layers, including when multiple such ejecta layers were included in a laminate (S7-S9), as well as to investigate the performance of laminates including additional aerogel layers.

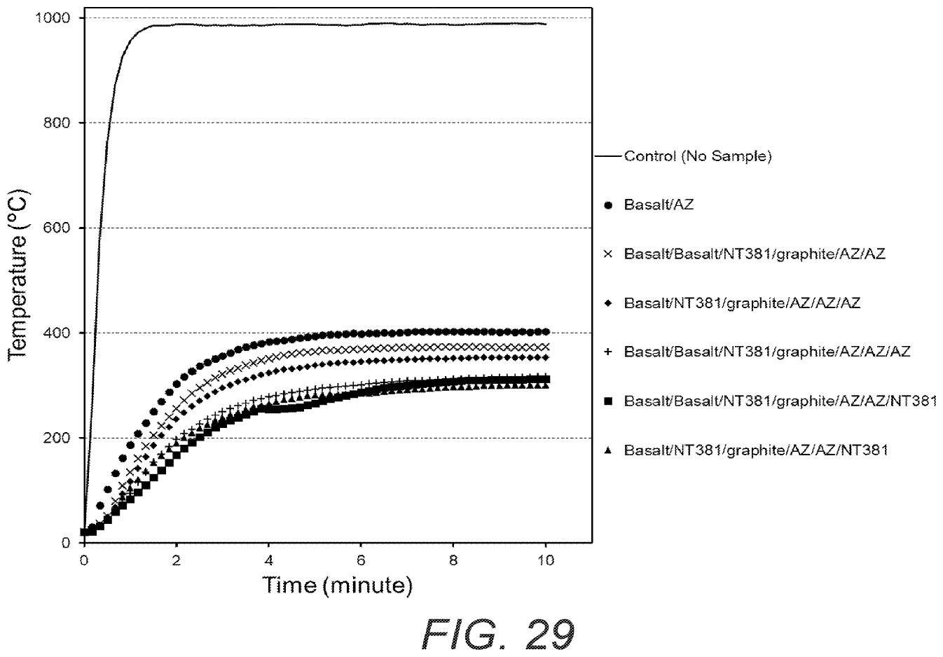

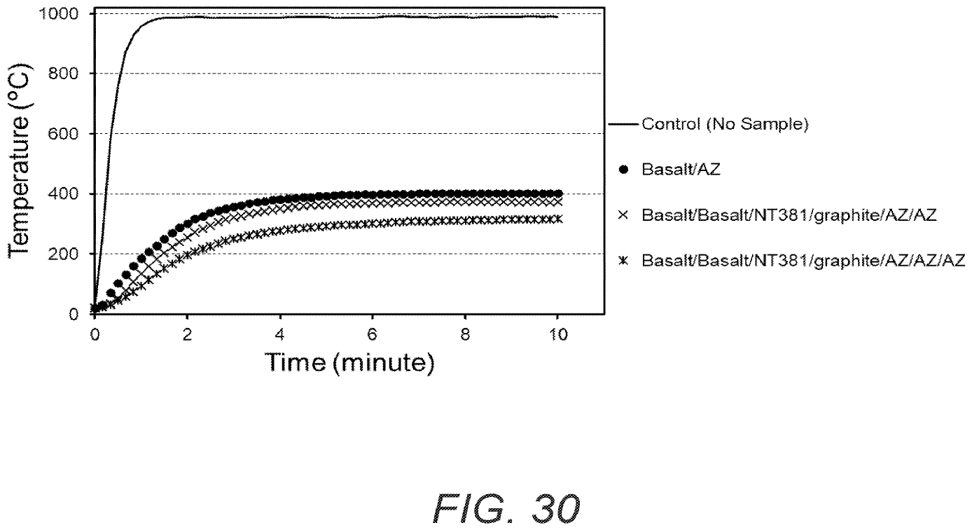

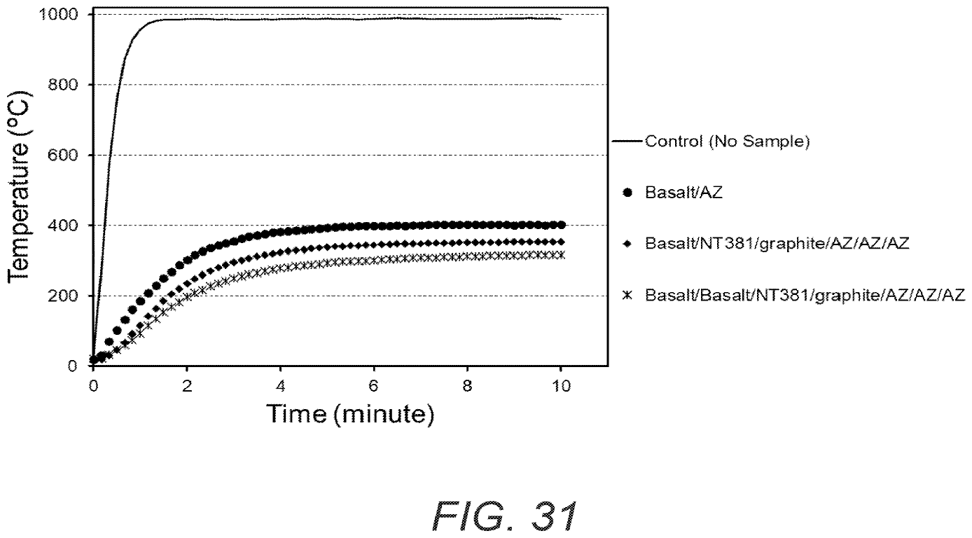

Results. The thermal profiles of the sample laminates are shown in FIGS. 29-31, and the cold-side temperature and difference between the hot-side temperature and the cold-side temperature at 5 and 10 minutes for each of the sample laminates are reported in TABLE 14.

TABLE 14
Laminate Temperatures During Sample Exposure to Flame

| | Cold- | Delta | Cold- | Delta |
|---|---|---|---|---|
| | Side | Temp @ | Side | Temp @ |
| | @ 5 | 5 min | @ 10 | 10 min |
| Sample | min (° C.) | (° C.) | min (° C.) | (° C.) |
| Control (No Sample) | 988 | NA | 988 | NA |
| 5. basalt/AZ | 394 | 594 | 403 | 585 |
| 6. basalt/NT381/ | 338 | 650 | 354 | 634 |
| graphite/AZ/AZ/AZ | | | | |
| 4. basalt/NT381/ | 282 | 706 | 301 | 687 |
| graphite/AZ/AZ/NT381 | | | | |
| 7. basalt/basalt/NT381/ | 365 | 623 | 373 | 615 |
| graphite/AZ/AZ | | | | |
| 8. basalt/basalt/NT381/ | 293 | 695 | 317 | 671 |
| graphite/AZ/AZ/AZ | | | | |
| 9. basalt/basalt/NT381/ | 267 | 721 | 313 | 675 |
| graphite/AZ/AZ/NT381 | | | | |

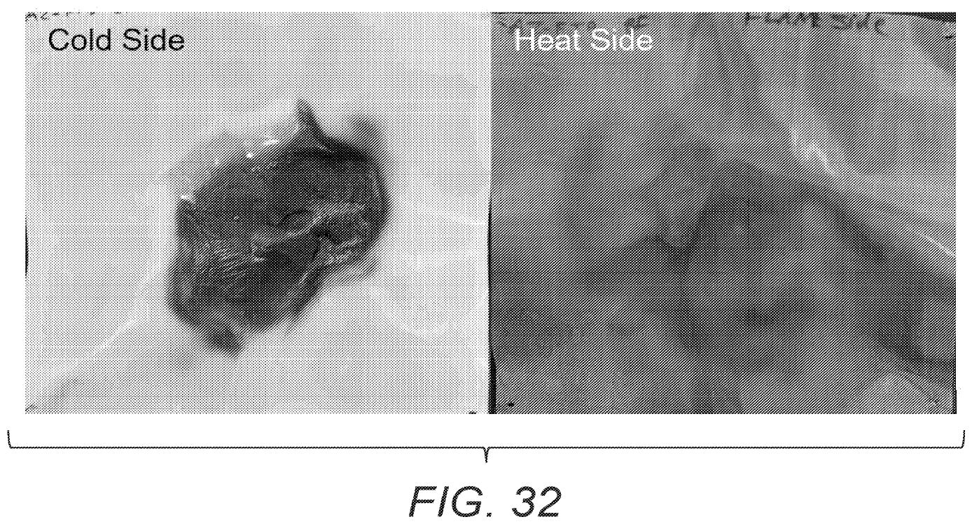

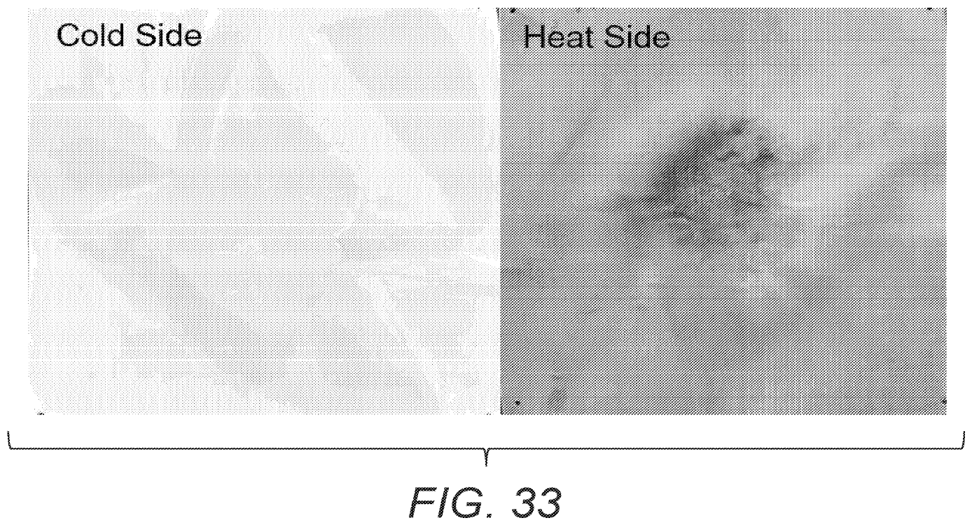

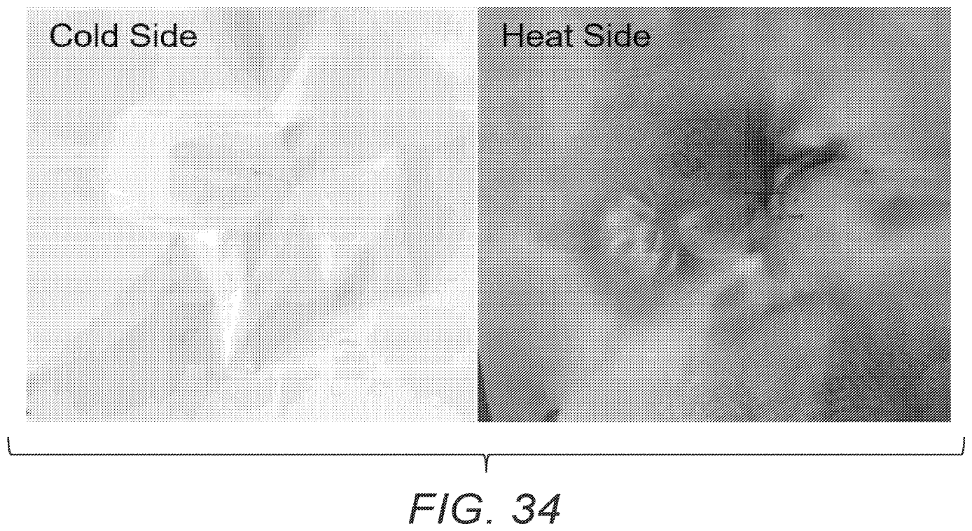

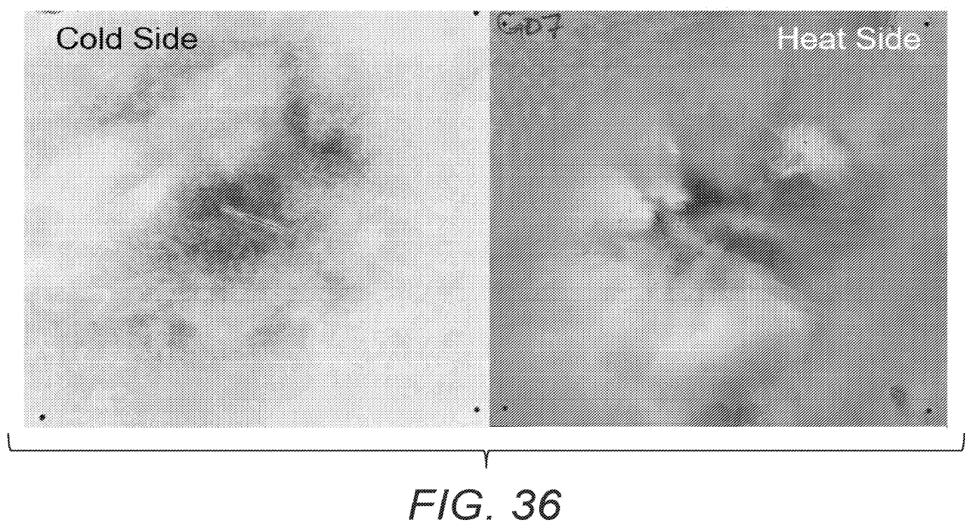

Each after 10 minutes of flame exposure, FIG. 32 shows S5's cold and hot sides, FIG. 33 shows S6's cold and hot sides, FIG. 28 shows S4's hot and cold sides, and FIGS. 34-36 show S7-S9's, respectively, cold and hot sides.

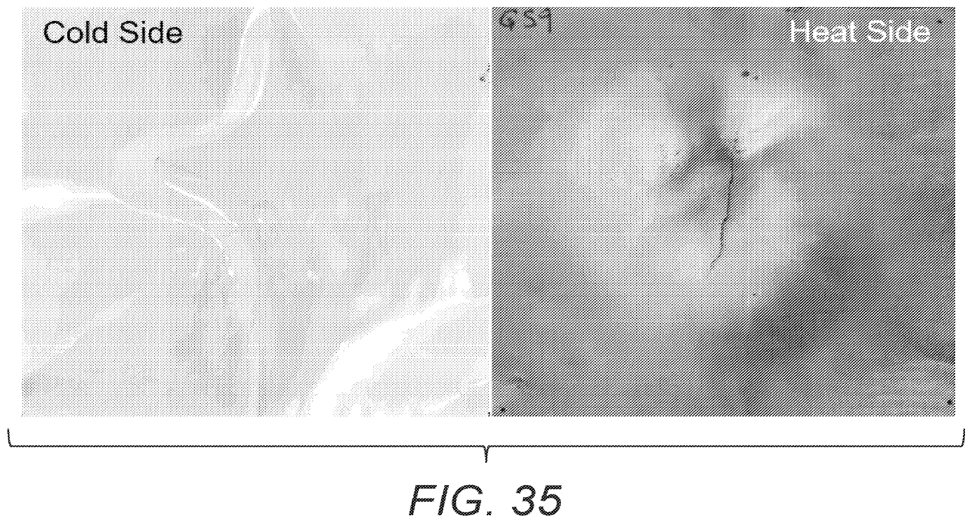

Results. The hot-side structural integrity of the sample laminates was good (FIGS. 32, 33, 28, and 34-36), which is believed to be a result of the basalt fabric ejecta layers, with cracking only appearing for S7 (FIG. 34) and S8 (FIG. 35). As to cold-side structural integrity, only S5—a relatively thin laminate consisting of a basalt fabric ejecta layer and an aerogel layer—showed burning (FIG. 32); the cold sides of the other sample laminates remained intact (FIGS. 28 and 33-36) with no burn-through. Indeed, the aerogel layers on the cold sides of S6-S8 were virtually unharmed. In all but S5, the basalt fabric ejecta layer stayed attached to the laminate sufficiently to provide protection to the underlying layers.

Turning to temperature-based performance, it was generally observed that laminate thickness is inversely proportional to laminate cold-side temperature. This can be seen by comparing relatively thin (0.28-mm-thick) laminate S5's cold-side temperature with those of thicker (1.11-1.40 mm-thick) laminates S4 and S6-S9. See also FIG. 29.

Sample laminates that included two basalt fabric ejecta layers also showed cold-side temperature improvements over sample laminates with only one basalt fabric ejecta layer. To illustrate, S8 was otherwise similar to S6 but included an additional basalt fabric ejecta layer, and S8's heating rate and cold-side temperatures were significantly reduced relative to S6's heating rate and cold-side temperatures (293° C. vs. 338° C. @ 5 minutes and 317° C. vs. 354° C. @ 10 minutes). To further illustrate, S9 was otherwise similar to S4, with S9 having included an additional basalt fabric ejecta layer, and S9 outperformed S4 with respect to cold-side temperature at 5 minutes (267° C. vs. 282° C.) and initial heating rate.

Further, improvements were observed for sample laminates that included more aerogel layers than others. Laminate S8 had the same lay-up as laminate S7 but included an additional aerogel layer. Laminate S8 showed significant reductions in heating rate and cold-side temperatures relative to laminate S7-293° C. vs. 365° C. @ 5 minutes and 317° C. vs. 373° C. @ 10 minutes—at only around a 10% increase in thickness.

### Example 10

### Flame and Thermal Barrier Laminates

TABLE 15 includes a list of flame and thermal barrier laminates created for use in battery-powered vehicles or devices to mitigate battery thermal runaway events.

TABLE 15
Examples of Flame and Thermal Barrier Laminates
for Mitigating Battery Thermal Runaway
Flame and Thermal Barrier Laminate Lay-up

NT381/AZ
fiberglass/NT381/graphite/AZ/AZ/AZ
basalt/NT381/graphite/AZ/AZ/AZ
NT381/AZ
WT145/AZ
WT145/AZ/AZ/WT145
WT145/graphite/AZ
WT145/graphite/AZ/AZ/AZ
fiberglass/graphite/AZ/AZ
NT381/graphite/AZ/AZ/NT381
basalt/basalt/NT381/graphite/AZ/AZ/AZ
WT145/graphite/AZ
WT145/graphite/AZ/AZ/AZ
WT145/graphite/AZ/AZ/AZ/AZ
NT381/graphite/AZ/AZ/NT381
NT381/graphite/AZ
fiberglass/graphite/AZ/AZ/AZ
basalt/basalt/NT381/graphite/AZ/AZ/AZ
basalt/NT381/AZ/AZ
NT381/graphite/AZ/AZ/NT381

The above specification and examples provide a complete description of the structure and use of illustrative embodiments. Although certain embodiments have been described above with a certain degree of particularity, or with reference to one or more individual embodiments, those of ordinary skill in the art could make numerous alterations to the disclosed embodiments without departing from the scope of this invention. As such, the various illustrative embodiments of the apparatuses and methods are not intended to be limited to the particular forms disclosed. Rather, they include all modifications and alternatives falling within the scope of the claims, and embodiments other than the ones shown may include some or all of the features of the depicted embodiments. For example, elements may be omitted or combined as a unitary structure, and/or connections may be substituted. Further, where appropriate, aspects of any of the examples described above may be combined with aspects of any of the other examples described to form further examples having comparable or different properties and/or functions and addressing the same or different problems. Similarly, it will be understood that the benefits and advantages described above may relate to one embodiment or may relate to several embodiments.

The claims are not intended to include, and should not be interpreted to include, means plus- or step-plus-function limitations, unless such a limitation is explicitly recited in a given claim using the phrase(s) “means for” or “step for,” respectively.

1. A laminate comprising:
a reinforcing layer comprising fibers;
a flame-retardant layer having a flammability rating compliant with UL94 5VA, UL94 5VB, or UL94 V-0;
a porous, thermally-insulative layer; and
a heat-dispersing layer comprising at least 90%, by weight, of a metal or graphite;
wherein a thickness of the laminate is less than or equal to 5 mm.

2. The laminate of claim 1, wherein the porous, thermally-insulative layer comprises an aerogel layer.

3. The laminate of claim 1, wherein the fibers of the reinforcing layer comprise glass fibers or basalt fibers.

4. The laminate of claim 1, wherein the fibers of the reinforcing layer are woven.

5. The laminate of claim 1, wherein:
the laminate has opposing front and back surfaces; and
each of the reinforcing layer, the flame-retardant layer, and the heat-dispersing layer is positioned closer to the front surface than is the porous, thermally-insulative layer.

6. The laminate of claim 5, wherein the flame-retardant layer is positioned between the reinforcing layer and the porous, thermally-insulative layer.

7. A laminate comprising:
an ejecta-mitigating layer;
a flame-retardant layer having a flammability rating compliant with UL94 5VA, UL94 5VB, or UL94 V-0; and
a porous, thermally-insulative layer;
wherein:
the laminate has opposing front and back surfaces; and
the ejecta-mitigating layer defines at least a majority of the front surface.

8. The laminate of claim 7, wherein the porous, thermally-insulative layer comprises an aerogel layer.

9. The laminate of claim 8, wherein the ejecta-mitigating layer comprises at least 90%, by weight, of a metal.

10. The laminate of claim 9, wherein the metal of the ejecta-mitigating layer comprises titanium.

11. The laminate of claim 8, wherein the ejecta-mitigating layer comprises fibers.

12. The laminate of claim 11, wherein the fibers of the ejecta-mitigating layer comprise glass fibers or basalt fibers.

13. The laminate of claim 11, wherein the fibers of the ejecta-mitigating layer are woven.

14. The laminate of claim 1, wherein the flame-retardant layer is inorganic-based.

15. The laminate of claim 1, wherein the flame-retardant layer comprises a paper.

16. The laminate of claim 1, wherein the flame-retardant layer comprises at least 90%, by wight, of a silicate.

17. The laminate of claim 1, wherein the flame-retardant layer comprises at least 90%, by weight, of a ceramic.

18. The laminate of claim 1, wherein a thickness of the flame-retardant layer is from 0.05 mm to 0.8 mm.

19. The laminate of claim 1, wherein the porous, thermally-insulative layer comprises at least 50%, by weight, of polyimide.

20. The laminate of claim 1, wherein the flammability rating of the laminate is compliant with UL94 5VA, UL94 5VB, or UL94 V-0.

21. The laminate of claim 1, comprising one or more adhesive layers coupled to the porous, thermally-insulative layer, including a first adhesive layer disposed between the flame-retardant layer and the porous, thermally-insulative layer.

22. The laminate of claim 1, comprising a second flame-retardant layer, wherein the flame-retardant layers are disposed on opposing sides of the porous, thermally-insulative layer.

23. An apparatus comprising a laminate of claim 1, comprising the laminate coupled to the apparatus.

24. The apparatus of claim 23, wherein the apparatus is a compression pad, a battery cell, a battery module, a battery pack, or a battery box.

25. The apparatus of claim 23, wherein the apparatus is an electrically-conductive cable.
